(19) United States
(12) Patent Application Publication
(10) Pub. No.: US 2024/0352605 A1
(43) Pub. Date: Oct. 24, 2024

(54) CATALYST AND METHODS FOR MAKING AND USING

(71) Applicants: Oregon State University, Corvallis, OR (US); Nanyang Technological University, Singapore (SG)

(72) Inventors: Yubo Chen, Singapore (SG); Zhenxing Feng, Corvallis, OR (US); Maoyu Wang, Corvallis, OR (US); Zhichuan Xu, Singapore (SG)

(73) Assignees: Oregon State University, Corvallis, OR (US); Nanyang Technological University, Singapore (SG)

(21) Appl. No.: 18/733,669

(22) Filed: Jun. 4, 2024

Related U.S. Application Data
(63) Continuation of application No. PCT/US2022/051987, filed on Dec. 6, 2022.
(60) Provisional application No. 63/323,188, filed on Mar. 24, 2022.
(60) Provisional application No. 63/286,967, filed on Dec. 7, 2021.

(51) Int. Cl. C25B 11/077; C25B 1/04; C25B 11/02

(52) U.S. Cl. CPC C25B 11/0773; C25B 11/02; C25B 1/04

(57) ABSTRACT

A method for making a catalyst comprises providing an initial compound having a perovskite lattice structure according to formula I

M¹M²M³O₃ FORMULA I,

where M¹ is about 1 relative elemental ratio strontium (Sr); M² is from greater than 0 to 0.7 relative elemental ratio and is selected from cobalt (Co), scandium (Sc), iron (Fe), nickel (Ni), and titanium (Ti); and M³ is 0.3 to 0.6 relative elemental ratio iridium (Ir). Initial exemplary compounds include SrSc_{0.5}Ir_{0.5}O₃ (SSI) and SrCo_{0.5}Ir_{0.5}O₃ (SCI). M¹ and/or M² cations are selectively leached from the initial compound to produce a catalyst having substantially increased catalytic performance. Cycling SSI or SCI in an acid produces SSI-H or SCI-H; cycling SSI or SCI in a base produces SSI-OH or SCI-OH. Dual-site metal leaching induced catalytic activity improvement by about 2 orders of magnitude, making reconstructed SrCo_{0.5}Ir_{0.5}O₃ among the best-known catalysts for water oxidation in an acidic condition.

### RELATED APPLICATIONS

This application is a continuation of PCT/US2022/051987, filed Dec. 6, 2022, which claims the benefit under 35 U.S.C. § 119 (e) of U.S. Provisional Application No. 63/286,967, filed on Dec. 7, 2021, and U.S. Provisional Application No. 63/323,188, filed on Mar. 24, 2022, the entire contents of each of which are incorporated herein by reference.

### ACKNOWLEDGMENT OF GOVERNMENT SUPPORT

This invention was made with government support under the Singapore National Research Foundation under its Campus for Research Excellence and Technological Enterprise (CREATE) program, through the Cambridge Center for Carbon Reduction in Chemical Technology (C4T), Grant No. EC8040 awarded by the Oregon State University Faculty Startup fund and Grant No. ECCS2025489 awarded by the National Science Foundation. The United States government has certain rights in the invention.

### FIELD

The present disclosure concerns catalyst compositions and methods of making and using such compositions. More specifically, the catalyst compositions described herein are formed by selective metal leaching from initial ABO₃ perovskite compounds having an initial M¹M²M³O₃ formula wherein the catalysts are useful, for example, for the electrolysis of water under acidic conditions.

### BACKGROUND

Increased energy demands and global warming issues are forcing society to rely more on renewable energy sources, which are often intermittently available. To mitigate this issue, converting electrical energy (provided by renewable energy sources) into chemical bonds through electrocatalysis, such as water electrolysis for hydrogen fuel, is a viable choice for energy storage.

In water electrolysis, the oxygen evolution reaction (OER), which occurs via a four-electron-transfer process, plays a pivotal role in determining the energy conversion efficiency. Its sluggish reaction kinetic greatly constrains the efficiency of the whole reaction, making the development of highly efficient OER catalysts one of the major challenges for implementing water electrolysis. To date, a wide variety of transition-metal-based materials have been explored for catalyzing the OER, both in acid and alkaline environments, and substantial improvements have been achieved. More recently, the existence of OER-induced surface reconstruction, mainly ion leaching and/or structural reorganization, has been widely detected with various catalysts, which range from metal alloys, metal sulfides/selenides/nitrides/phosphides, and metal oxides. Among them, the perovskite-type complex oxides, such as (Ba_{0.5}Sr_{0.5}) (Co_{0.8}Fe_{0.2})O_{3-δ} and strontium iridate (SrIrO₃), have demonstrated superior OER activity due to the presence of unique surface reconstructions. However, although the observations of perovskite surface reconstruction have been intensively reported, designing advanced perovskite pre-catalysts to generate highly active reconstructed surfaces for OER is still a challenge. This, to a great extent, is due to the complexity of the entire reconstruction process, which has not been fully understood.

### SUMMARY

The present disclosure provides a method for designing advanced perovskite pre-catalysts and using such advanced perovskite pre-catalysts to make catalysts having highly active reconstructed surfaces that are useful for, for example, performing the OER. Catalysts made by the method are also disclosed.

One disclosed embodiment for making a catalyst comprises providing an initial compound having a perovskite lattice structure according to formula I

M¹M²M³O₃ FORMULA I.

With reference to Formula I, M¹ is about 1 relative elemental ratio strontium (Sr); M² is from greater than 0 to 0.7 relative elemental ratio, preferably 0.5, and is selected from cobalt (Co), scandium (Sc), iron (Fe), nickel (Ni), and titanium (Ti); and M³ is 0.3 to 0.6 elemental ratio, preferably 0.5 elemental ratio, iridium (Ir). Certain initial compounds, comprising 0.5 Sc or Co and 0.5 iridium, included SrSc_{0.5}Ir_{0.5}O₃ (SSI) and SrCo_{0.5}Ir_{0.5}O₃ (SCI). M¹ and/or M² cations are then selectively leached from the initial compound, such as by electrochemical cycling, to produce a catalyst having substantially increased catalytic performance compared to the initial compound. Exemplary catalysts include SSI-H, SCI-H, SSI-OH and SCI-OH.

Leaching metal atoms, such as strontium atoms, from an initial crystalline perovskite lattice forms an amorphous surface having reduced metal concentration. Electrochemically cycling involves cycling the initial compound plural times in an acid, such as perchloric acid (HClO₄), or a base, such as a metal hydroxide, exemplified by KOH. The initial compounds may be electrochemically cycled until a compositional steady state is reached, a structural steady state is reached, and/or a catalytic activity steady state is reached. Cycling SSI or SCI in an acid produces SSI-H or SCI-H, whereas cycling SSI or SCI in a base produces SSI-OH or SCI-OH. Without being limited to a particular theory of operation, cycling is believed to: reconstruct the perovskite surface from a crystalline structure to an amorphous structure with A-site cation (Sr) leaching, which induces an activity improvement of approximately one order of magnitude; leach B-site cations, which induces further activity improvement of approximately one order of magnitude; increases surface area available for catalytic activity; and any and all combinations thereof.

Metal leaching from the initial compound forms a highly active amorphous IrOₓH_{y} surface phase where X and Y fulfill an equation 4+Y=2X. For certain embodiments, X is 3, Y is 2, and the catalyst had an amorphous H₂IrO₃-honeycomb structure and an electrochemical surface area substantially higher than that of the initial compound. The catalyst typically has an amorphous surface structure having a depth of greater than 0 nanometers to at least 50 nanometers, more particularly 10 nanometers to at least 50 nanometers. For certain embodiments, subsequent to cycling in acid, the compound was SSI-H or SCI-H and the strontium surface concentration was reduced to substantially 0 relative elemental ratio to 0.2 relative elemental ratio. For other embodiments, subsequent to cycling in base, the compound was SCI-OH and the strontium surface concentration was reduced to 0.6 relative elemental ratio to 0.7 relative elemental ratio.

Cycling substantially increases catalytic activity. SCI-H, for example, has a geometry-surface-area-normalized OER current (j_{geo}) at 1.5 V versus a reversible hydrogen electrode (RHE) that is 150 times greater than that of SSI-OH. For particular embodiments, the catalyst is SCI-H having a Brunauer-Emmett-Teller (BET) normalized activity (j_{geo}) of 7.5±1.0 mA cm²; the catalyst is SSI-H having a BET-normalized activity (j_{geo}) of 3.5±0.5 mA cm⁻²; the catalyst is SCI-OH having a BET-normalized activity (j_{geo}) of 0.4±0.1 mA cm⁻²; or the catalyst is SSI-OH having a BET-normalized activity (j_{geo}) of 0.05±0.01 mA cm⁻². The amorphous IrOₓH_{y} surface phase has an intrinsic activity (j_{ECSA}), which refers to the current density normalized to electrochemical surface area (ECSA) at 1.5 V versus RHE as shown by FIG. 19, more than two orders of magnitude higher than the activity of rutile IrO₂. For particular embodiments, the catalyst is SCI-H having an ECSA-normalized activity (j_{ECSA}) of 0.15 mA cm⁻² (in a range from 0.055 to 0.40 mA cm⁻²); the catalyst is SSI-H having an ECSA-normalized activity (j_{ECSA}) of 0.2 mA cm⁻² (in a range from 0.07 to 0.54 mA cm⁻²); or the catalyst is SCI-OH having an ECSA-normalized activity (j_{ECSA}) of 0.02 mA cm⁻² (in a range of from 0.008 to 0.046 mA cm⁻²) and SSI-OH having an ECSA-normalized activity (j_{ECSA}) of 0.025 mA cm⁻² (in a range of from 0.015 to 0.03 mA cm⁻²).

The catalysts of the present disclosure may be particularly formulated for use in an acid environment. For example, certain disclosed embodiments are designed for use in an acidic environment having a pH of 3.0 or less, preferably a pH of 2.3 or less.

A particular disclosed method embodiment for making catalysts according to the present invention comprises providing an initial compound having a perovskite lattice structure according to formula I

M¹M²M³O₃ FORMULA I.

With reference to Formula I, M¹ is about 1 relative elemental ratio strontium (Sr); M² is from greater than 0 to 0.7 relative elemental ratio and is selected from cobalt (Co) and scandium (Sc); and M³ is 0.3 to 0.6 relative elemental ratio iridium (Ir). Two representative initial compounds are SrSc_{0.5}Ir_{0.5}O₃ (SSI) and SrCo_{0.5}Ir_{0.5}O₃ (SCI). M¹ and/or M² cations are then selectively leached from the initial compound, such as by electrochemically cycling the initial compound plural times in a base or an acid, thereby producing a catalyst having substantially increased catalytic performance compared to the initial compound. Electrochemical cycling continues until the initial compound reaches a compositional steady state, a structural steady state, and/or a catalytic activity steady state. For certain disclosed embodiments, the initial compound was cycled approximately 50 times to achieve a suitable steady state. The initial compound may be electrochemically cycled in an acid, which produces SSI-H or SCI-H compounds. For SSI-H and SCI-H, the strontium surface concentration was substantially reduced to be within the range of substantially 0 elemental ratio to 0.2 elemental ratio. The initial compound also can be electrochemically cycled in a base, which produces SSI-OH or SCI-OH. For SSI-OH and SCI-OH, the strontium surface concentration was reduced to be within the range of between 0.6 elemental ratio to 0.7 elemental ratio. Electrochemically cycling the initial compound leaches cations from a surface portion of the initial compound, thereby forming a highly active amorphous surface phase having a depth of greater than 0 nanometers to at least 50 nanometers. For certain disclosed embodiments, the highly active amorphous surface phase was an H₂IrO₃-honeycomb phase.

A more particular embodiment of the present invention comprises calcining appropriate stochiometric amounts of reagents selected from SrCO₃, IrO₂, Co₃O₄, and Sc₂O₃ (Sigma Aldrich, 99.9%) at a temperature of 1,100° C. or greater to form an initial compound selected from SrSc_{0.5}Ir_{0.5}O₃ (SSI) or SrCo_{0.5}Ir_{0.5}O₃ (SCI). Again, the initial compound is electrochemically cycled in an acid to produce SSI-H or SCI-H, or electrochemically cycled in a base to produce SSI-OH or SCI-OH, thereby forming a catalyst having a highly active amorphous H₂IrO₃-honeycomb surface phase having a depth of greater than 0 nanometers to at least 50 nanometers.

The present invention also concerns catalysts produced according to disclosed method embodiments. Certain disclosed catalyst embodiments comprise a core portion having a formula I

M¹M²M³O₃ FORMULA I.

With reference to Formula I, M¹ is about 1 relative elemental ratio strontium (Sr); M² is from greater than 0 to 0.7 relative elemental ratio and is selected from cobalt (Co) and scandium (Sc); and M³ is 0.3 to 0.6 relative elemental ratio iridium (Ir). Disclosed catalysts also comprise an outer surface portion from which M¹ and/or M² cations have been selectively leached in an acid, such as perchloric acid, thereby reducing the strontium concentration in the outer surface portion to a range between 0 relative elemental ratio to 0.2 elemental ratio. Alternatively, M¹ and/or M² cations may be selectively leached from the initial compound in a base, thereby reducing the strontium concentration in the outer surface portion to a range between 0.6 elemental ratio to 0.7 elemental ratio relative to the core portion concentration. The outer surface portion extends from the surface of the catalyst to a depth of at least 50 nanometers. Metal leaching forms a highly active amorphous IrOₓH_{y} surface phase where X and Y fulfill an equation 4+Y=2X. For certain embodiments, X is 3, Y is 2, and the catalyst had an amorphous H₂IrO₃-honeycomb structure and an electrochemical surface area substantially higher than that of the initial compound.

Catalysts produced according to the present invention can be used to perform catalytic reactions. For example, disclosed catalysts can be used to perform a water oxidation reaction.

The foregoing and other objects, features, and advantages of the invention will become more apparent from the following detailed description, which proceeds with reference to the accompanying figures.

### BRIEF DESCRIPTION OF THE DRAWINGS

FIGS. 1a-1e illustrate a theoretical prediction of model perovskites' surface stability.

FIG. 1a is a schematic illustrating that dissolution of A-site Sr (the blue ball) from the sub-surface layer of SrSc_{0.5}Ir_{0.5}O₃ (also referred to as SSI) to electrolyte can be kinetically blocked by the cage composed of B-site (Ir/Sc) octahedra, where the Sr atom away from the surface is considered to be bulk Sr (the green ball).

FIG. 1b illustrates an SSI surface without a B-site (Sc) vacancy.

FIG. 1c illustrates an SSI surface with a B-site (Sc) vacancy.

FIG. 1d provides an energy diagram that illustrates the dissolution of A-site (Sr) from the sub-surface of SSI without a B-site (Sc) vacancy.

FIG. 1e provides an energy diagram that illustrates the dissolution of A-site (Sr) from the sub-surface of SSI with a B-site (Sc) vacancy. With reference to FIGS. 1b-1e, solely for purposes of better illustration, only the selected sub-surface Sr atom that migrates to the outer-surface is blue, and all the rest sub-surface Sr atoms are green.

FIGS. 2a-2f illustrate the initial state of Ir in model perovskite catalysts.

FIG. 2a is a Rietveld refinement of the XRD patterns for SSI, with a corresponding SEM inset.

FIG. 2b is a Rietveld refinement of the XRD patterns from SCI, with a corresponding SEM inset.

FIG. 2c provides HR-TEM images from the surfaces of two pristine perovskites.

FIG. 2d provides XANES spectra collected at Ir Lₘ-edge from SSI, SCI, and rutile IrO₂.

FIG. 2e provides XANES spectra collected at Ir Lₘ-edge at the corresponding second-derivative from SSI, SCI, and rutile IrO₂.

FIG. 2f is a Fourier-transformed (FT) k³-weighted Ir Lₘ-edge EXAFS spectra from pristine SSI and SCI, where the dashed lines are fitting profiles for the first Ir—O shell.

FIGS. 3a-3n concern surface reconstruction in model perovskites.

FIG. 3a is a CV profile of SrSc_{0.5}Ir_{0.5}O₃ cycled in 0.1 M KOH to produce SSI-OH.

FIG. 3b is a CV profile of SrSc_{0.5}Ir_{0.5}O₃ cycled in 0.1 M KOH (SSI-OH).

FIG. 3c is a surface TEM image of SrSc_{0.5}Ir_{0.5}O₃ cycled in 0.1 M KOH (SSI-OH).

FIG. 3d is a CV profile of SrCo_{0.5}Ir_{0.5}O₃ cycled in 0.1 M KOH to produce SCI-OH.

FIG. 3e is a CV profile of SrCo_{0.5}Ir_{0.5}O₃ cycled in 0.1 M KOH (SCI-OH).

FIG. 3f is a surface TEM image of SrCo_{0.5}Ir_{0.5}O₃ cycled in 0.1 M KOH (SCI-OH).

FIG. 3g is a CV profile of SrSc_{0.5}Ir_{0.5}O₃ cycled in 0.1 M HClO₄ (perchloric acid) to produce SSI-H.

FIG. 3h is a CV profile of SrSc_{0.5}Ir_{0.5}O₃ cycled in 0.1 M HClO₄ (SSI-H).

FIG. 3i is a surface TEM image of SrSc_{0.5}Ir_{0.5}O₃ cycled in 0.1 M HClO₄ (SSI-H).

FIG. 3j is a CV profile of SrCo_{0.5}Ir_{0.5}O₃ cycled in 0.1 M HClO₄ to produce SCI-H.

FIG. 3k is a CV profile of SrCo_{0.5}Ir_{0.5}O₃ cycled in 0.1 M HClO₄ (SCI-H).

FIG. 3l is a surface TEM image of SrCo_{0.5}Ir_{0.5}O₃ cycled in 0.1 M HClO₄ (SCI-H).

FIG. 3m illustrates composition changes of all four sample surfaces from the XPS results.

FIG. 3n is a schematic drawing illustrating the surface status in all four samples.

FIGS. 4a-4c illustrate activity evolution during surface reconstruction.

FIG. 4a provides BET-normalized activities from SSI-OH, SCI-OH, SSI-H, and SCI-H, where the inset shows the BET-normalized OER currents at 1.5 V versus RHE, and the error bars denote the standard error of three independent tests.

FIG. 4b provides the intrinsic OER current (normalized to ECSA) densities versus potential from all four samples, where the intrinsic OER current for IrO₂ is from an IrO₂ (110) thin film in 0.1 M HClO₄.

FIG. 4c provides the overpotentials required for different samples to reach a turnover frequency of 0.03 s⁻¹.

FIGS. 5a-5f illustrate the state of the active Ir-site for reconstructed surfaces.

FIG. 5a provides XANES spectra collected at Ir Lₘ-edges from pristine SCI, SCI-H, and IrO₂.

FIG. 5b provides XANES spectra collected at the corresponding second-derivative from pristine SCI, SCI-H, and IrO₂.

FIG. 5c provides FT k³-weighted Ir Lₘ-edge EXAFS spectra for pristine SCI, SCI-H, and IrO₂.

FIG. 5d illustrates the relationship between Ir—O bond lengths and Debye-Waller (DW) factors, where the dashed line is the reported positive correlation between Ir—O bond lengths and DW factors in Ir-based perovskites.

FIG. 5e are O K-edge spectra from the pristine and electrochemically cycled SSI, where projected density of states (PDOS) of O_p, Ir_d, Sc_d, Co_d, Sr_d, Ir_sp, Sc_sp, and Co_sp state from pristine SSI are also presented from indexing the O K-edge spectra, with the intensity of the Sc_d state in SSI is divided by 5 and all the spectra are recorded in TEY mode.

FIG. 5f are O K-edge spectra from the pristine and electrochemically cycled SCI, where projected density of states (PDOS) of O_p, Ir_d, Sc_d, Co_d, Sr_d, Ir_sp, Sc_sp, and Co_sp state from pristine SSI are also presented from indexing the O K-edge spectra, with the intensity of the Sc_d state in SSI is divided by 5 and all the spectra are recorded in TEY mode.

FIGS. 6a-6h provide a likely structure of the reconstructed perovskite surface.

FIG. 6a provides measured O K-edge spectra, recorded in TEY mode, and the PDOS from rutile IrO₂, with the Fermi energy set to zero.

FIG. 6b provides featured pre-edge peaks from the measured O K-edge spectra of SCI-H and IrO₂, where the dashed line is the difference between the two measured O K-edge spectra.

FIG. 6c is an H₂IrO₃ with a layered honeycomb structure, which is the most likely structure of the reconstructed perovskite surface.

FIG. 6d provides simulated O K-edge spectra and the PDOS from H₂IrO₃ (honeycomb), with the Fermi energy set to zero.

FIG. 6e provides featured pre-edge peaks from simulated O K-edge spectra of H₂IrO₃ (honeycomb) and IrO₂, where the dashed curve is the difference between the two simulated O K-edge spectra.

FIG. 6f provides simulated pH-potential phase diagrams for the honeycomb H₂IrO₃ surface.

FIG. 6g provides a standard free energy diagram for OER, where the asterisk represents the active site.

FIG. 6h provides the calculated theoretical overpotentials for IrOOH (brucite), IrO₂ (rutile), and H₂IrO₃ (honeycomb).

FIGS. 7a-7b are Pourbaix diagrams for cobalt and scandium, where the data presented is from the materialsproject.org and the concentration of ions is 10⁻⁶ M.

FIG. 7a provides a Pourbaix diagram for Co, which is thermodynamically unstable at both high pH (HCoO²⁻) values and low pH (Co²⁺) values.

FIG. 7b provides a Pourbaix diagram for Sc, which is thermodynamically stable at high pH (Sc₂₃) values but unstable at low pH (Sc³⁺) values.

FIGS. 8a-8b are energy diagrams that provide theoretical predictions of SrCo_{0.5}Ir_{0.5}O₃ surface stability.

FIG. 8a is an energy diagram that illustrates the dissolution of A-site (Sr) from the sub-surface of SrCo_{0.5}Ir_{0.5}O₃ without a B-site (Co) vacancy, where the dissolution of outer surface Sr into the electrolyte is not considered for SrCo_{0.5}Ir_{0.5}O₃ surface without Co vacancy because that Co cannot be stable in either high or low pH values.

FIG. 8b is an energy diagram that illustrates the dissolution of A-site (Sr) from the sub-surface of SrCo_{0.5}Ir_{0.5}O₃ with (b) a B-site (Co) vacancy, where the dissolution of outer surface Sr into the electrolyte is not considered for SrCo_{0.5}Ir_{0.5}O₃ surface without Co vacancy because that Co cannot be stable in either high or low pH values.

FIG. 9 is a schematic diagram illustrating dissolution of lattice Sr, from the outer-surface, into the electrolyte as Sr²⁺ ion.

FIGS. 10a-10d illustrate migration of lattice Sr from sub-surface to outer-surface where, for a better expression, only two atom layers of surface B-site layer and sub-surface A-site layer are shown, and intermediate state 2 (IS2) and intermediate state 3 (IS3) are selected for SSI and SSI with an Sc vacancy, respectively.

FIGS. 10a and 10b are top views of an initial state of model SSI with and without a Sc vacancy.

FIGS. 10c and 10d are top views of intermediate states of model SSI with and without a Sc vacancy.

FIG. 11 concerns crystal structures of perovskite surfaces and provides HR-TEM images of the surface crystal structure of two model perovskites (SrSc_{0.5}Ir_{0.5}O₃ and SrCo_{0.5}Ir_{0.5}O₃) before (pristine) and after cycling in 0.1 M KOH and 0.1 M HClO₄.

FIG. 12 concerns an index of perovskite surface structures and provides FFT images corresponding to the TEM images in FIG. 11.

FIGS. 13a-13d concern the status of Co and Sc in the perovskite structure.

FIG. 13a provides Co K-edge XANES spectra from LaCoO₃ and SrCo_{0.5}Ir_{0.5}O₃, where the inset is the corresponding first derivative.

FIG. 13b provides EXAFS spectra from LaCoO₃ and SrCo_{0.5}Ir_{0.5}O₃.

FIG. 13c provides Sc K-edge XANES spectra from Sc₂O₃ and SrSc_{0.5}Ir_{0.5}O₃.

FIG. 13d provides EXAFS spectra from Sc₂O₃ and SrSc_{0.5}Ir_{0.5}O₃.

FIG. 14 concerns an estimation of the electrochemical surface area of SSI-OH, with the first CV cycle of SrSc_{0.5}Ir_{0.5}O₃ in alkaline condition (SSI-OH), where the conversion of redox charge to surface area is realized with the Ir atom density in crystalized perovskite surface with different exposed facets and the surface Ir density (ρ_{Ir}) is 2.217×10¹⁴ Ir/cm² and 3.225×10¹⁴ Ir/cm² for the (100) facet and (001) facet, respectively. The corresponding surface area (A) can be calculated using

$$A = \frac{Q}{e \times {ρ}_{Ir}}$$

where Q is the integral charge from redox peak (Ir⁴⁺ to Ir³⁺), e is the charge of a single electron. The calculated surface area is 1.03 cm² and 0.71 cm² for the (100) facet and (001) facet, respectively. These two surface areas are close to the measured ECSA of 1.25±0.32 cm² from impedance analysis (FIG. 18), indicating that only the Ir from the outer perovskite surface is involved.

FIGS. 15a-15i concern the evolution of Ir nanoparticles from perovskite surfaces.

FIG. 15a is an HR-TEM image of the pristine SrCo_{0.5}Ir_{0.5}O₃ with electron beam illumination, with the inset being the corresponding FFT image.

FIG. 15b is a STEM image of the pristine SrCo_{0.5}Ir_{0.5}O₃ with electron beam illumination, with the inset being the corresponding FFT image.

FIG. 15c is a TEM image of the SrCo_{0.5}Ir_{0.5}O₃ surface with the formation of nanoparticles.

FIG. 15d is a TEM image of the local structure of a nanoparticle shown by FIG. 15c.

FIG. 15e is a corresponding FFT image of SrCo_{0.5}Ir_{0.5}O₃, which can be indexed with Ir metal.

FIG. 15f is a TEM image of SrCo_{0.5}Ir_{0.5}O₃ cycled in acid. After electron beam illumination, many nanoparticles evolved from the reconstructed amorphous surface, and the inset is an SAED pattern from the surface region, where the SAED pattern can be indexed with Ir metal, confirming that the electron beam illumination induces the formation of Ir nanoparticles.

FIGS. 15g and 15i illustrate the evolution of TEM images taken from the reconstructed surface of SrCo_{0.5}Ir_{0.5}O₃ cycled in acid, where images were taken at 10 seconds and 30 seconds, and after approximately 30 seconds of electron beam exposure, numerous black Ir nanoparticles evolve.

FIG. 16 concerns variations of SSI surface composition, and provides XPS spectra from as-prepared SSI, SSI cycled in KOH, and SSI cycled in HClO₄, where the fitting parameters are listed in Table 3.

FIG. 17 concerns variations of SCI surface composition, and provides XPS spectra from as-prepared SCI, SCI cycled in KOH, and SCI cycled in HClO₄, where the fitting parameters are listed in Table 4.

FIG. 18 concerns calculation of ECSA with EIS.

FIG. 19 concerns OER currents with the consideration of Cₛ variation, with the OER current (normalized to ECSA) densities at 1.5 V from all four samples, where the ECSA is calculated with the consideration of Cₛ variation, and irrespective of large error induced by specific capacitance, the intrinsic current densities of SSI-H and SCI-H are substantially higher than the intrinsic current densities of SSI-OH and SCI-OH, confirming the promoting effect of surface reconstruction and the importance of B-site metal leaching.

FIGS. 20a-20b concern details of a pulse voltammetry protocol.

FIG. 20a provides the potential step applied in a pulse voltammetry protocol, with the potential versus RHE changes between 1.35 V (cathodic) and 1.42 V to 1.8 V (anodic), and the potential was held for 10 seconds for each step.

FIG. 20b provides the current response of a typical anodic and cathodic section, where the OER current is from SCI-H.

FIGS. 21a-21c′ concern correlations between current response and total charge.

FIGS. 21a-c provide measured current response and total charge of SCI-OH from pulse voltammetry.

FIGS. 21a′-c′ provide measured current response and total charge of SCI-H from pulse voltammetry, with FIGS. 21a and 21a′ providing Tafel plots of potential (iR corrected versus RHE) versus logarithm of OER current. For SCI-OH with A-site cation leaching, the bending starts at a potential of ˜1.55 V. For SCI-H with additional B-site cation leaching, the bending starts at a potential of ˜1.48 V. FIGS. 21b and 21b′ provide the total charge (integral cathodic charge) versus potential (iR corrected versus RHE). FIGS. 21c and 21c′ provide the total charge versus logarithm of OER current.

FIG. 22 concerns calculated electronic structures of model perovskites for the crystal structures of SrSc_{0.5}Ir_{0.5}O₃ and SrCo_{0.5}Ir_{0.5}O₃ and the corresponding PDOS of Ir_d and O_p states.

FIGS. 23a-23b concern measured O K-edge spectra from perovskite bulk.

FIG. 23a provides O K-edge spectra from pristine and electrochemically cycled SrSc_{0.5}Ir_{0.5}O₃.

FIG. 23b provides O K-edge spectra from pristine and electrochemically cycled SrCo_{0.5}Ir_{0.5}O₃. For FIGS. 23, XAS tests were performed in the total fluorescence yield model (TFY), which is more bulk sensitive compared with the XAS tests in the TEY model (FIG. 5). The spectra from both samples, cycled in acid, are different from the ones from pristine samples, which corresponds well with the TEM results (FIG. 11) indicating that the perovskite surface regions thoroughly reconstructed with increased depth in acid.

FIG. 24 concerns measured O K-edge spectra from perovskite bulk and reconstructed surface and O K-edge spectra of SrSc_{0.5}Ir_{0.5}O₃ and SrCo_{0.5}Ir_{0.5}O₃ from STEM-EELS analysis, where both samples were electrochemically cycled in 01 M HClO₄, and the signals are collected from either crystalized bulk or reconstructed outer surface. After surface reconstruction, the featured pre-edge peaks, related to π*, cannot be observed. This should be related to its greatly reduced intensity (FIG. 5e-5f), which makes collecting corresponding EELS signals difficult.

FIG. 25 concerns a comparison of O K-edge spectra from reconstructed surfaces of SSI-H and SCI-H.

FIG. 26 concerns calculated electronic structures of rutile IrO₂, and provides the crystal structure of IrO₂ and the corresponding PDOS of Ir_d and O_p states, where the calculated PDOS is close to the one reported by T. Reier, Z. Pawolek, S. Cherevko, M. Bruns, T. Jones, D. Teschner, S. r. Selve, A. Bergmann, H. N. Nong, R. Schlögl, Molecular insight in structure and activity of highly efficient, low-Ir Ir—Ni oxide catalysts for electrochemical water splitting (OER). J. Am. Chem. Soc. 137, 13031-13040 (2015).

FIG. 27 concerns possible structural motifs and provides a series of possible structures for the IrOₓH_{y} phase from the reconstructed perovskite surface where, based on the XAS results, four possible structures of IrO₂-rutile, H₂IrO₃-honeycomb, H₂IrO₃-F, and IrOOH-brucite are considered. Because the oxidation state of Ir in IrOₓH_{y} is close to 4 and the material should be electrically neutral, the value of x and y should fulfill the equation of 4+y=2X. If x=2, the stoichiometry is IrO₂. In this case, the IrO₂ with a rutile structure is possible. If x≥3, the proton should exist in the bulk. That is the formation of Ir-based (oxy) hydroxide. However, prior to the present disclosure, only a layered IrOOH, with Ir³⁺, had been reported. D. Weber, L. M. Schoop, D. Wurmbrand, J. r. Nuss, E. M. Seibel, F. F. Tafti, H. Ji, R. J. Cava, R. E. Dinnebier, B. V. Lotsch, Trivalent iridium oxides: layered triangular lattice iridate K_{0.75}Na_{0.25}IrO₂ and oxyhydroxide IrOOH. Chem. Mater. 29, 8338-8345 (2017). Considering that lithium should be the element most close to a proton, the present disclosure considers more possible structures from the Li—Ir—O system. α-Li₂IrO₃ (space group: C 12/ml) and B-Li₂IrO₃ (space group: F ddd) are found to be constructed with edge-shared IrO6 octahedrons. Thus, replacing Li with H, H₂IrO₃-honeycomb (from α-Li₂IrO₃) and H₂IrO₃-F (from βLi₂IrO₃) two additional possible structures for the reconstructed perovskite surface. Additionally, the reported IrOOH-brucite is considered even though its bulk activity is just comparable with the rutile IrO₂, because, in previous studies on perovskite surface reconstruction, the reconstructed surfaces were also considered to be transition metal oxyhydroxides, which are active toward OER.

FIG. 28 concerns simulated O K-edge spectra and electronic structures of possible structural motifs and provides simulated O K-edge spectra (left column) from IrO₂-rutile, H₂IrO₃-honeycomb, H₂IrO₃-F, and IrOOH-brucite, where featured pre-edge peaks (middle column) are indexed with the corresponding PDOS (right column).

FIGS. 29a-29d concern deprotonation of the honeycomb H₂IrO₃ at different (from 1/8 to 1/1) deprotonation stages.

### DETAILED DESCRIPTION

### I. DEFINITIONS, TERMS AND NUMERICAL RANGES

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to a person of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from prior art, the embodiment numbers are not approximates unless the word “about” is recited.

### II. ABBREVIATIONS

CV: Cyclic voltammetry.
DFT: Density functional theory.
DLC: Double layer capacitance.
HR-TEM: High resolution transmission electron microscopy.
OER: Oxygen evolution reaction.
RHE: Reversible hydrogen electrode.
SCI: SrCo_{0.5}Ir_{0.5}O₃.
SCI-H: SrCo_{0.5}Ir_{0.5}O₃ cycled in acid, such as 0.1 M HClO₄.
SCI-OH: SrCo_{0.5}Ir_{0.5}O₃ cycled in base, such as 0.1 M KOH.
SSI: SrSc_{0.5}Ir_{0.5}O₃.
SSI-H: SrSc_{0.5}Ir_{0.5}O₃ cycled in, such as 0.1 M HClO₄.
SSI-OH: SrSc_{0.5}Ir_{0.5}O₃ cycled in base, such as 0.1 M KOH.
TEY: total-electron-yield (TEY).
TOF: Turnover frequency.
TMs: Transition metals.
XAS: X-ray absorption spectroscopy.

### III. COMPOUNDS

The present disclosure concerns novel catalyst compounds and methods for making and using such compounds. The catalysts are produced from initial compounds by electrically cycling such compounds in a base or acid electrolyte, which leaches cations, such as strontium, from the initial compound. Cation leaching continues with continued cycling and results in reconstructing the surface of the initial compound to have both a new composition and a new 3-dimensional structure. This produces a catalyst having substantially enhanced activity relative to the initial compound.

Initial compounds according to the present invention generally are ABO₃ perovskites of Formula I

M¹M²M³O₃ FORMULA I.

For most inorganic ABO₃ perovskites, the A-site is occupied by alkaline-earth-metals and lanthanides, which, with their relatively large ionic size (>1 Å), are indispensable for supporting the framework of corner-shared B-site octahedra. Some A-site cations are soluble in water, even in alkaline conditions. As a result, a heavy dissolution of A-site cations is widely observed during the surface reconstruction in benchmark perovskite catalysts. The B-site can be occupied by various transition metals, which are active toward catalyzing OER. Normally, transition metals with good thermodynamic stability are used as B-site cations. In alkaline conditions, Fe, Co, and Ni are generally used, while Ir is used in acidic conditions because of its high corrosion resistance. The ABO₃ perovskite may have, for example, strontium as an A site element, and a transition metal or metal pair B site, such as an Sc/Co B site.

As a result, with reference to Formula I, specific compounds of the present invention include those where M¹ is 1 elemental ratio strontium (Sr); M² is from greater than 0 elemental ratio to 0.7 elemental ratio, typically 0.5 elemental ratio, and is selected from cobalt (Co), scandium (Sc), iron (Fe), nickel (Ni) and titanium (Ti), preferably cobalt and scandium; and M³ is 0.3 elemental ratio to 0.6 elemental ratio, typically 0.5 elemental ratio, Iridium (Ir).

Two particular exemplary initial compounds exemplifying the present disclosure are SrCo_{0.5}Ir_{0.5}O₃ (also referred to as SCO) and SrSc_{0.5}Ir_{0.5}O₃ (also referred to as SCI). These initial compounds are prepared using SrCO₃ (Sigma Aldrich, 99.9%), IrO₂ (Sigma Aldrich, 99.9%), Co₃O₄ (Sigma Aldrich), and Sc₂O₃ (Sigma Aldrich, 99.9%). Appropriate stochiometric amounts of these reagents were thoroughly ground and calcined for 12 hours under ambient air at 1,150° C. to produce SrCo_{0.5}Ir_{0.5}O₃, and at 1,350° C. to produce SrSc_{0.5}Ir_{0.5}O₃.

The catalytic activity of initial compounds according to Formula I are substantially improved by cycling in either a base, such as 0.1 KOH, or in an acid, such as HClO₄. Cycling can be accomplished, for example, by forming an electrode comprising the initial compound, and cycling the electrode for 50 cyclic voltammetry cycles (between 0.3 V and 1.8 V vs. RHE without iR correction) to ensure that the reconstructed surface reaches a steady status. Cycling SrCo_{0.5}Ir_{0.5}O₃ in an acid, such as 0.1 M HClO₄, produces a new structure, referred to herein as SCI-H, whereas cycling SrSc_{0.5}Ir_{0.5}O₃ in 0.1 M HClO₄ produces a new structure referred to herein as SSI-H. Similarly, cycling SrCo_{0.5}Ir_{0.5}Oin a base, such as 0.1 M KOH, produces SCI-OH, and cycling SrSc_{0.5}Ir_{0.5}O₃ in 0.1 M KOH produces SSI-OH.

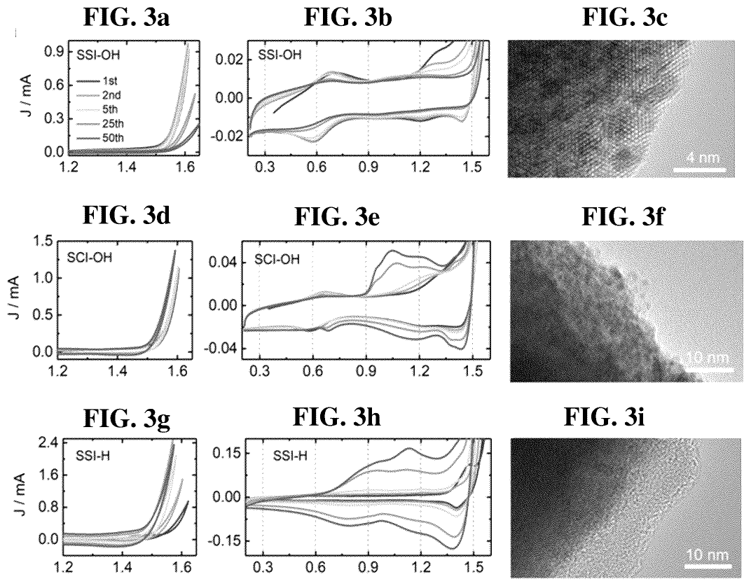

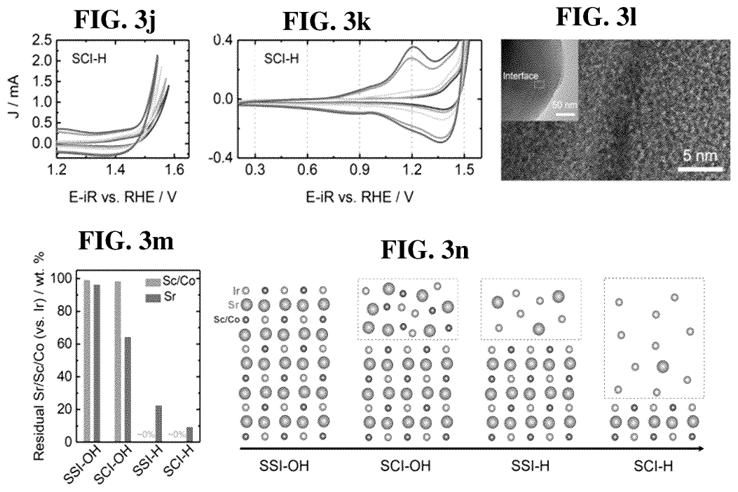

FIG. 3n is a graph of residual Sr/Sc/Co (vs. Ir) weight percent that provides the amount of Sr, Sc or Co that leaches from the initial compound during electrochemical cycling. FIG. 3n shows that, at least for SCI-OH, SSI-H and SCI-H, the relative weight percent of strontium is reduced substantially by cycling. For example, subsequent to cycling in acid, the compound is SSI-H or SCI-H and the strontium surface concentration is reduced to 0.3 elemental ratio or less, thereby producing a surface having substantially 0 relative elemental ratio to 0.2 elemental ratio Sr. That is, the catalyst may have a final Sr composition of from 0.1 to 0.3 elemental ratio. Other elements, such as Co and Sc could experience different degrees of leaching (e.g., almost all Co leached out and all Sc leached out) while Ir may not change. As another example, subsequent to cycling in base the compound is SCI-OH and the strontium surface concentration is reduced to 0.6 elemental ratio to 0.7 elemental ratio.

Cycling also changes the physical structure of the initial compound to form an amorphous surface structure having a depth of greater than 0 nanometers to at least 50 nanometers, and more typically a depth of 10 nanometers to 50 nanometers. The amorphous structure is an IrOₓH_{y} structure that likely is IrO₂-rutile, H₂IrO₃-honeycomb, H₂IrO₃-F, or IrOOH-brucite, most likely H₂IrO₃-honeycomb. X and Y fulfill an equation 4+Y=2X, and for certain exemplary embodiments, X=3 and Y=2.

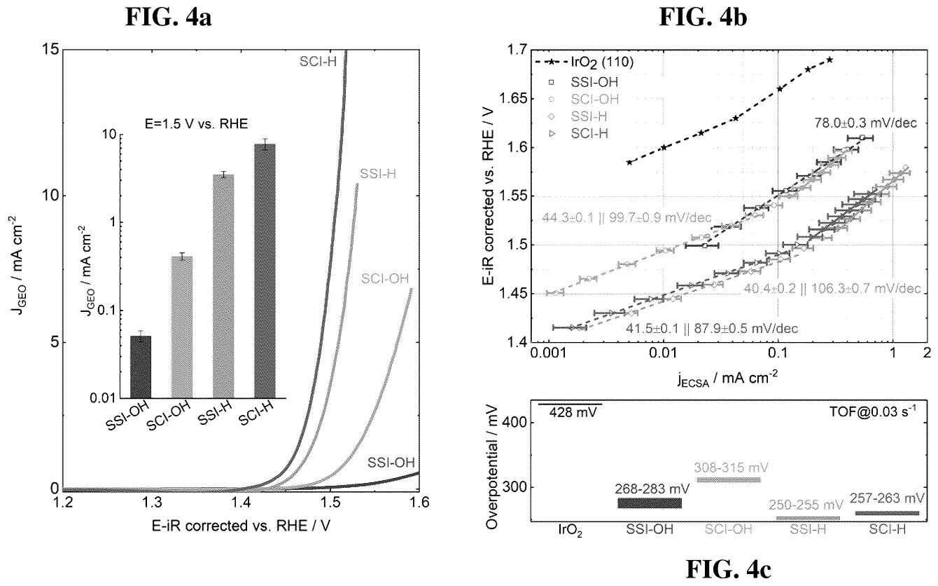

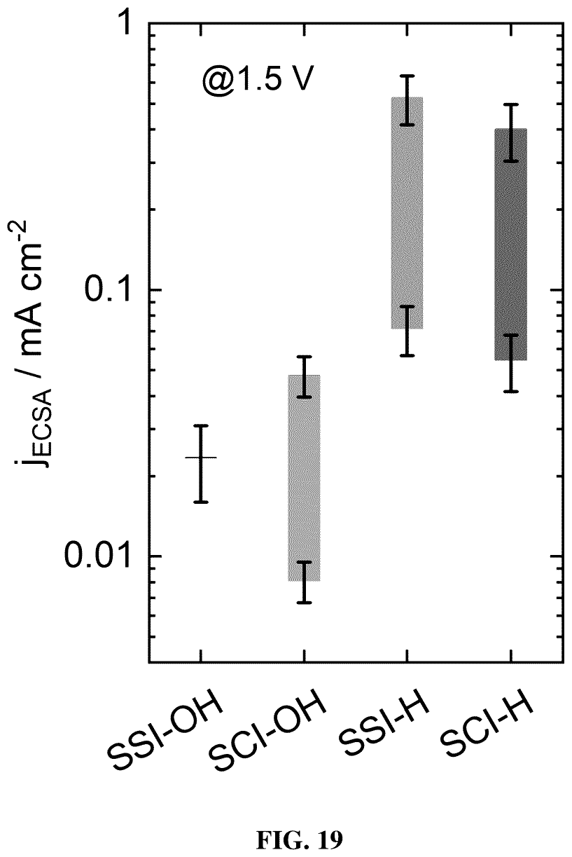

Cation leaching forms the highly active amorphous IrOₓH_{y} surface phase. For example, the amorphous IrOₓH_{y} surface phase may have an intrinsic activity that is more than two orders of magnitude higher than the activity of a rutile IrO₂. The activities of SSI-OH, SCI-OH, SSI-H and SCI-H are provided by FIG. 4. To date, SCI-H has provided the best catalytic activity results for water oxidation in acid, where the SCI-H has a geometry-surface-area-normalized oxygen evolution reaction current (j_{geo}) at 1.5 V versus a reversible hydrogen electrode that is approximately 20 times greater than that of SCI-OH and 150 times greater than that of SSI-OH. For particular embodiments, the catalyst is SCI-H having a BET-normalized activity (j_{geo}) of 7.5±1.0 mA cm⁻²; the catalyst is SSI-H having a BET-normalized activity (j_{geo}) of 3.5±0.5 mA cm⁻²; the catalyst is SCI-OH having a BET-normalized activity (j_{geo}) of 0.4±0.1 mA cm⁻²; or the catalyst is SSI-OH having a BET-normalized activity (j_{geo}) of 0.05±0.01 mA cm⁻². The amorphous IrOₓH_{y} surface phase has an intrinsic activity (j_{ECSA}), which refers to the current density normalized to electrochemical surface area (ECSA) at 1.5 V versus reversible hydrogen electrode (RHE) as shown in FIG. 19, more than two orders of magnitude higher than the activity of rutile IrO₂. More particularly, the catalyst is SCI-H having an ECSA-normalized activity (j_{ECSA}) of 0.15 mA cm⁻² (in a range from 0.055 to 0.40 mA cm⁻²); the catalyst is SSI-H having an ECSA-normalized activity (j_{ECSA} ) of 0.2 mA cm⁻² (in a range from 0.07 to 0.54 mA cm⁻²); or the catalyst is SCI-OH having an ECSA-normalized activity (j_{ECSA}) of 0.02 mA cm⁻² (in a range from 0.008 to 0.046 mA cm⁻²) and SSI-OH having an ECSA-normalized activity (j_{ECSA}) of 0.025 mA cm⁻² (in a range from 0.015 to 0.03 mA cm⁻²).

### IV. DISCUSSION

In most inorganic ABO₃ perovskites, the A-site is occupied by alkaline-earth-metals and lanthanides, which, with their relatively large ionic size (>1 Å), are indispensable for supporting the framework of corner-shared B-site octahedra. Some A-site cations are soluble in water, even in alkaline conditions. As a result, a heavy dissolution of A-site cations is widely observed during the surface reconstruction in benchmark perovskite catalysts. The B-site can be occupied by various transition metals (TMs), which are active towards catalyzing OER. Normally, TMs with good thermodynamic stability are employed as B-site cations. For example, in alkaline conditions, Fe, Co, and Ni are generally utilized, while Ir is used in acidic conditions due to its high corrosion resistance. Thus, the leaching of B-site cations is rather weak as compared to A-site cations. Cation leaching is generally accompanied by a considerable increase in electrochemical surface area for OER. Nonetheless, deliberate cation leaching (as sacrificial agent) from the initial bulk can induce the formation of unique local structural environments, such as reactive surface hydroxyls and activated oxygen ligands, which can promote activity. Given that a typical perovskite contains two types of metal cations (A-site and B-site) in totally different structural environments and both of them can leach out during surface reconstruction, identifying the role of metal cation leaching at each site is pivotal for understanding the relationship between the activity evolution and the surface reconstruction. On the other hand, a consensus is that the reconstructed surface, in contact with an electrolyte, is the final active phase towards OER. Therefore, a better understanding of the formed surfaces is essential too.

Prior to the present disclosure, the formed active surface phases after metal cation leaching have been elucidated case-by-case. A resemblance of the reconstructed surface phases to the (oxy)hydroxides has been suggested based on the detection of edge-shared octahedra with X-ray absorption analysis. The formation of phases, akin to the initial perovskite structure, have also been predicted by density functional theory (DFT) calculations in a SrIrO₃ perovskite. Nevertheless, probing the exact structural motif of the surface phase is still challenging as the perovskite surface is generally amorphized after the reconstruction.

The present disclosure presents a step-by-step strategy to control the metal cation leaching from each geometric site in perovskites, such as two Ir-based exemplary perovskites, to understand their activity evolution and the role of the metal leaching at each site. The perovskites of SrSc_{0.5}Ir_{0.5}O₃ (SSI) and SrCo_{0.5}Ir_{0.5}O₃ (SCI) are employed as model catalysts. Metal cation leaching and the accompanied surface reconstruction can be controlled by tailoring the thermodynamic stability of B-site cations. A thorough reconstruction, including the metal cation leaching and structural rearrangement, induces a remarkable activity improvement by approximately 150 times (1.5 V vs. reversible hydrogen electrode (RHE)), which makes SCI among the best catalysts for OER in acid. A-site cation leaching creates more electrochemical area available for catalyzing OER and the additional B-site cation leaching induces the formation of a highly active amorphous IrOₓH_{y} surface phase, which has an intrinsic activity more than two orders of magnitude higher than the activity of a rutile IrO₂. The surface-sensitive X-ray absorption analysis and DFT simulations indicate a honeycomb-like structure of the reconstructed amorphous IrOₓH_{y}.

To evaluate activity evolution during surface reconstruction and to identify the effects of metal leaching, the ability to precisely manipulate surface metal leaching was a prerequisite. The present disclosure provides a surface reconstruction mechanism, starting from the perovskite structure, which mechanism allows precise control of the perovskite surface metal leaching and accompanied reconstruction.

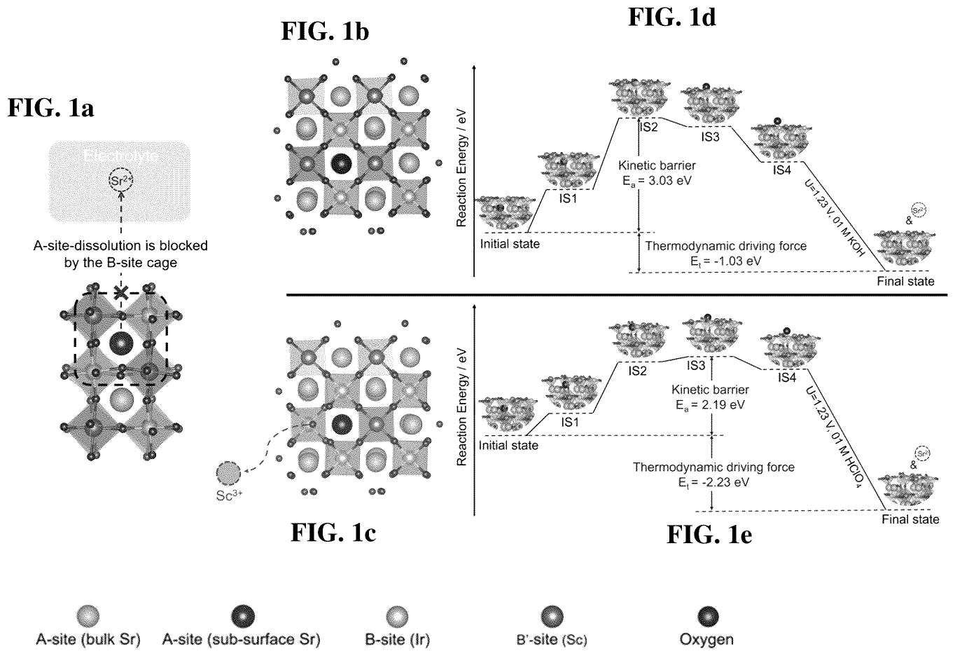

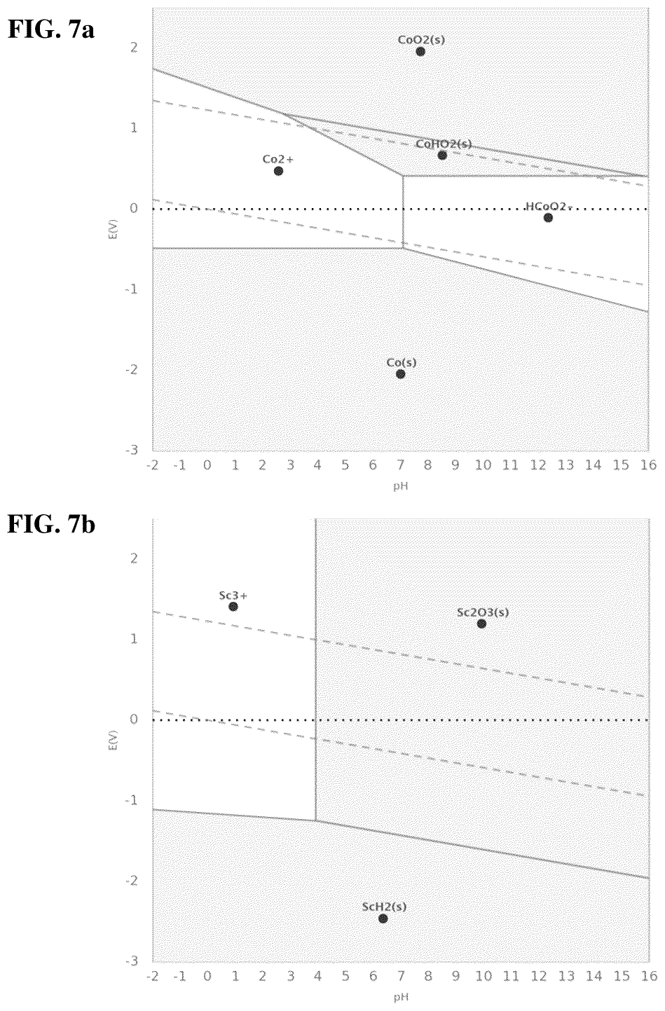

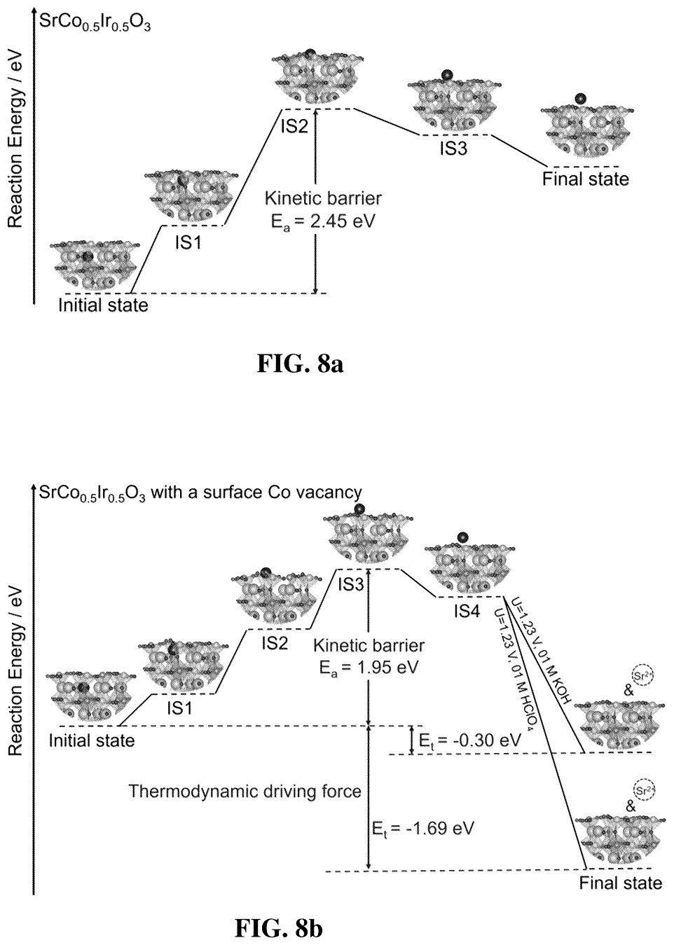

FIG. 1a shows a typical perovskite structure of SSI where a soluble A-site Sr atom locates in the cage composed of dense-packed B-site (Ir/Sc) octahedra. For the possible leaching of Sr atom from the perovskite lattice to electrolyte, a large obstacle exists if the B-site octahedra are highly stable. In other words, the leaching of A-site Sr as well as the perovskite surface stability is correlated with the thermodynamic stability of B-site cations. In the model perovskites of SCI and SSI, the B-site elements of Co and Sc, whose solubilities are sensitive to the pH of the electrolyte, are then used to tune stability (FIG. 7). For a better understanding of such an effect toward controlling the A-site dissolution, computational studies were performed. Without being limited to a theory of operation, a new model is postulated which integrates both lattice A-site cation migration (from sub-surface to outer-surface) and cation dissolution (from outer-surface to the electrolyte) to explain perovskite surface reconstruction at the atomic level. As illustrated by FIG. 1b-e (SSI) and FIG. 8 (SCI), the thermodynamic B-site stability is simulated by constructing two perovskite surfaces without (FIG. 1b) and with (FIG. 1c) a B-site vacancy, respectively.

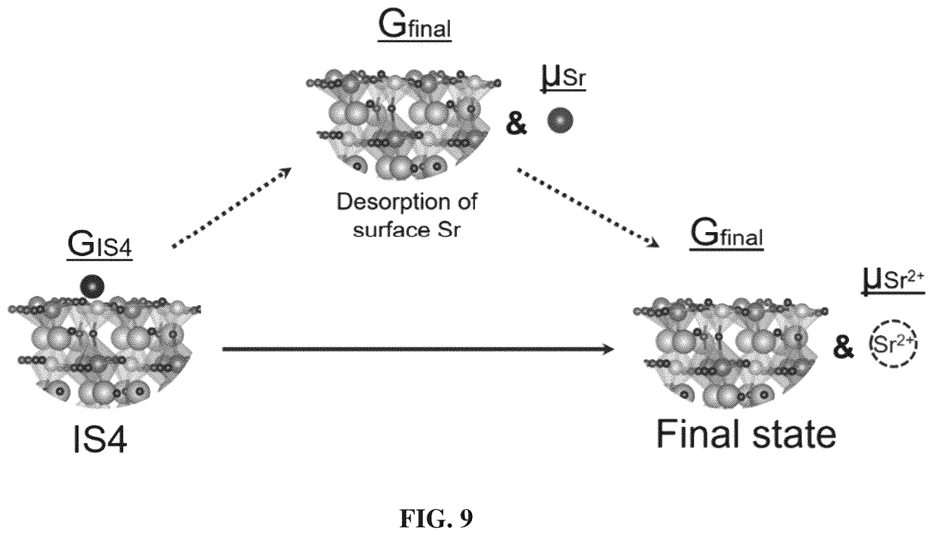

Strontium dissolution includes two stages (FIG. 1d, e). The first stage, from the initial state to intermediate state (IS) 4, is the migration of a lattice Sr from the sub-surface to the outer-surface, which is controlled by a kinetic barrier. In this stage, the sub-surface Sr migrates straight towards the outer-surface. This is also a likely diffusion path of A-site cation in perovskite lattice. Intermediate states are then generated along the straightforward Sr migration path. For the second stage, the effects of both potential and pH are considered. Specifically, a potential of 1.23 V (versus RHE), which is the thermodynamic equilibrium potential of water electrolysis, is applied. Because Sc is only stable in high-pH solutions, 0.1 M KOH (pH=12.82) and 0.1 M HClO₄ (pH=1.08) were used to evaluate the creation of a surface without B-site (Sc) vacancy and with a B-site (Sc) vacancy in SSI, respectively. More calculation details for the second stage are provided by FIG. 9.

TABLE 1
Calculated Free Energies (Ev) of Different Surfaces

| | | Initial | | | | | Final |
|---|---|---|---|---|---|---|---|
| | | state | IS1 | IS2 | IS3 | IS4 | state |
| Sr(Sc_{0.5}Ir_{0.5})O₃ | No Sc | −825.83 | −825.49 | −822.80 | −823.32 | −823.84 | −818.11 |
| | vacancy | | | | | | |
| | With Sc | −812.30 | −811.86 | −810.29 | −810.11 | −810.69 | −810.69 |
| | vacancy | | | | | | |
| Sr(Co_{0.5}Ir_{0.5})O₃ | No Co | −807.67 | −807.21 | −805.22 | −805.49 | / | 805.86* |
| | vacancy | | | | | | |
| | With Co | −800.32 | −800.12 | −799.22 | −798.37 | −798.80 | −791.87 |
| | vacancy | | | | | | |

*The final state for Sr(Co_{0.5}Ir_{0.5})O₃ with no Co vacancy is a surface with a Sr adsorbed on the outer surface.

As shown by FIG. 9, the second stage of A-site Sr dissolution (IS4 to final state) includes two sub-steps. In the first sub-step, a lattice Sr, which migrates from the sub-surface to the outer surface, leaves the surface as a single atomic Sr. The free-energy change for this step (ΔG₁) can be expressed as:

$$Δ {G}_{1} = {G}_{final} + {μ}_{Sr} - {G}_{IS 4} \qquad ( 1 )$$

G_{IS4} and G_{final} are the free energies of the surfaces before and after the desorption of surface Sr, respectively. μ_{Sr} is the chemical potential of the Sr atom. Such chemical potential is estimated by calculating the chemical potential of a Sr metal model, in which a face-centered cubic Sr crystal is constructed for calculation.

The second sub-step is the dissolution of atomic Sr into the electrolyte (Sr=Sr²⁺+2e⁻). The free-energy change for dissolution of atomic Sr (ΔG₂) can be expressed as:

$$Δ {G}_{2} = {μ}_{{Sr}^{2 +}} + 2 {μ}_{{e}^{-}} - {μ}_{Sr} \qquad ( 2 )$$

Where μ_{Sr}_{²⁺} and μₑ_{^{−}} are the chemical potential of Sr²⁺ and e⁻. The ΔG₁ for the first step is calculated based on DFT. The calculation details are discussed below. The ΔG₂ is calculated with a standard hydrogen electrode as the reference. Under the operational condition, the chemical potential of μ_{Sr}²⁺ and μₑ⁻ can be correlated to the standard states by

$${μ}_{{Sr}^{2 +}} = {μ}_{{Sr}^{2 +}}^{°} + kT ln {a}_{{Sr}^{2 +}} \qquad ( 3 )$$

$${μ}_{{e}^{-}} = {μ}_{{e}^{-}}^{°} - {eU}_{SHE} \qquad ( 4 )$$

Substitution of the above two equations into equation (2) gives

$$Δ {G}_{2} = Δ {G}_{SHE}^{°} - 2 {eU}_{SHE} + kT ln {a}_{{Sr}^{2 +}} \qquad ( 5 )$$

where ΔG⁶⁰² _{SHE} and a_{Sr}_{²⁺} are standard hydrogen electrode free energy of Sr and the Sr²⁺ ion concentration. For Sr, the ΔG⁶⁰² _{SHE} value is −5.8 eV and the a_{Sr}_{²⁺} is fixed at 10⁻⁶ M.

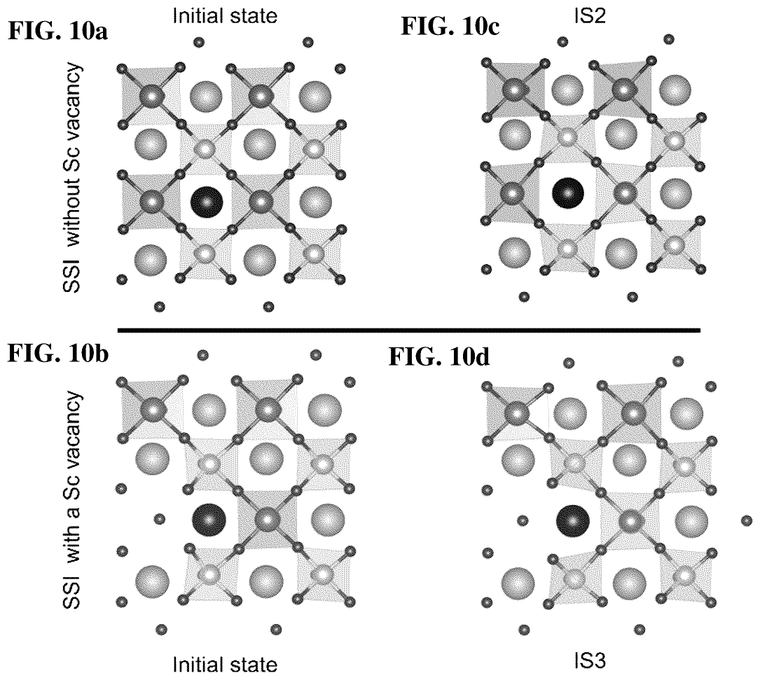

At the ideal surface of SrSc_{0.5}Ir_{0.5}O₃ without any B-site (Sc) defects, the migration of a lattice Sr from sub-surface to the outer-surface requires an activation energy (Eₐ) of 3.03 eV (FIG. 1d), which is much higher than 2.19 eV from the surface with a B-site (Sc) vacancy (FIG. 1e). The lower Eₐ in the surface with a Sc vacancy can be explained by the larger space available for Sr migration (see FIG. 10). The Sr will move through an aperture constructed by four (FIG. 10c without Sc vacancy) or three (FIG. 10d with an Sc vacancy) surface corner-shared BO5 square pyramids. Due to the large ionic size of Sr, the surface atoms must relax substantially to allow the migration of Sr, hinting at the existence of steric hindrance for Sr migration. This is reflected in the distorted BO5 square pyramids in IS2 from SSI and IS3 from SSI with an Sc vacancy. Due to the existence of an Sc vacancy, the BO5 square pyramids in FIG. 10d can distort more freely to make more space available for Sr migration. As a result, a lower kinetic barrier for Sr migration is found from an SSI structure having an Sc vacancy.

A similar decrease in activation energy (from 2.45 eV to 1.95 eV) is obtained in SrCo_{0.5}Ir_{0.5}O₃ by creating a surface B-site (Co) vacancy (FIG. 8). Apparently, the migration of sub-surface Sr to the outer-surface becomes easier when a B-site vacancy occurs. This corresponds well with the speculation that the leaching of sub-surface Sr is determined by the B-site cages. The kinetic barrier can and likely will decrease further, as multiple surface B-site vacancies can exist simultaneously due to the thermodynamically unstable feature of B-site cations. Thus, the kinetic barrier can be very sensitive to the thermodynamic stability of B-site cations. As for the second stage (IS4 to the final state), the thermodynamic driving force (Ex) is always negative, indicating that the Sr dissolution can be spontaneous after it migrates to the outer-surface (IS4). Computational studies suggest that, in the proposed perovskite reconstruction mechanism, the dissolution of A-site cations is strongly correlated with the stability of B-site cages.

### A. Initial State of Ir in Model Perovskite Catalysts

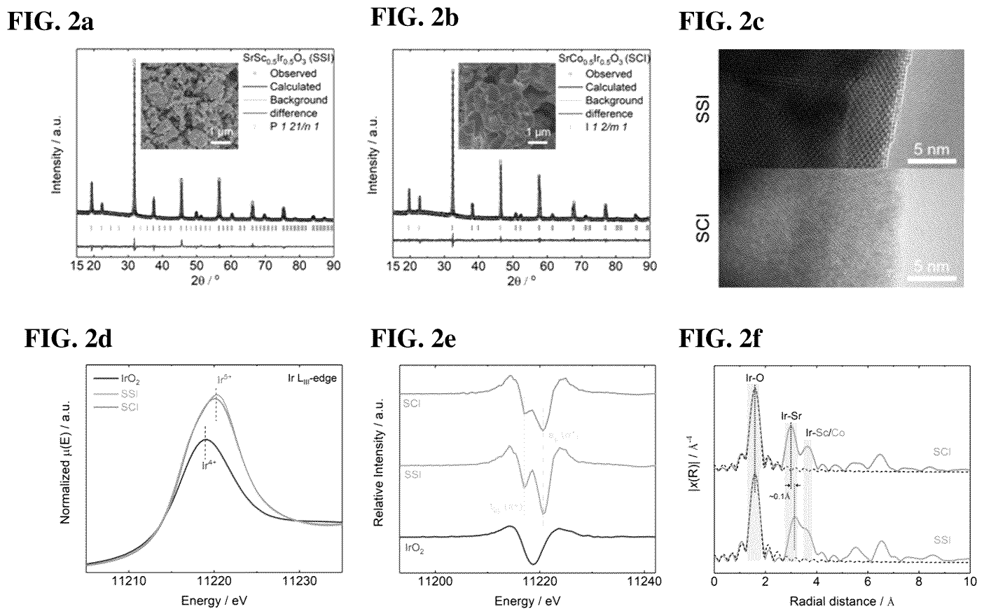

Two model SSI and SCI perovskites were synthesized via a solid-state method as discussed below in Example 1. Their double perovskite structures, having a chemical formula A₂(BB′)O₆ as compared to perovskite's ABO₃ formula, with high phase purity, are confirmed by Rietveld refinement of the XRD patterns (FIGS. 2a, 2b, and Table 2). As shown by the FIGS. 2a and 2b insets, SSI has a relatively smaller particle size. This corresponds well with the measured Brunauer-Emmett-Teller (BET) surface areas of 0.53 m²g⁻¹ and 0.18 m²g⁻¹ for SSI and SCI, respectively.

TABLE 2
Refined Structure Information

| | SrSc_{0.5}Ir_{0.5}O₃ | | | SrCo_{0.5}Ir_{0.5}O₃ | |
|---|---|---|---|---|---|
| Space group | P 1 21/n 1 | | | I 1 2/m 1 | |
| a(Å) | 5.6439(3) | | | 5.5338(2) | |
| b(Å) | 5.6407(3) | | | 5.5477(1) | |
| c(Å) | 7.9968(2) | | | 7.8436(2) | |
| | Sr | | | | |
| Wyckoff | 4i | | | 4i | |
| site | (0.487(7), 0.495(2), 0.232(0)) | | | (0.504(1), 0, 0.249(0)) | |
| Occ. | 1 | | | 1 | |
| Uᵢₛₒ (Å²) | 0.0142 | | | 0.0203 | |
| | Sc | | | Co | |
| Wyckoff | 2c | 2d | | 2a | 2d |
| site | (0, ½, 0) | (½, 0, 0) | | (0, 0, 0) | (0, 0, ½) |
| Occ. | 0.887(1) | 0.113(1) | | 0.860(3) | 0.140(3) |
| Uᵢₛₒ (Å²) | 0.0261 | 0.0261 | | 0.0361 | 0.0183 |
| | Ir | | | Ir | |
| Wyckoff | 2c | 2d | | 2a | 2d |
| site | (0, ½, 0) | (½, 0, 0) | | (0, 0, 0) | (0, 0, ½) |
| Occ. | 0.113(1) | 0.887(1) | | 0.140(3) | 0.860(3) |
| Uᵢₛₒ (Å²) | 0.0261 | 0.0261 | | 0.0361 | 0.0183 |
| | O* | | | | |
| Wyckoff | 4e | 4e | 4e | 4i | 8j |
| site | (0.248(10), | (0.258(10), | (0.433(3), | (0.013(6), | (0.205(3), |
| | 0.265(9), | 0.738(10), | −0.009(11), | 0, | 0.282(3), |
| | −0.017(4)) | −0.050(3)) | 0.247(2)) | 0.246(5)) | 0.020(2)) |

| Occ. | 1 | |
|---|---|---|
| Uᵢₛₒ (Å²) | 0.025 | |
| | Rₚ = 4.45% | Rₚ = 3.22% |
| | R_{wp} = 5.83% | R_{wp} = 4.07% |
| | Chi\hat{ }² = 1.720 | Chi\hat{ }² = 1.296 |

*During the refinement, for O, the values of site occupancy and Uᵢₛₒ are constrained to be 1 and 0.025 Å², respectively.

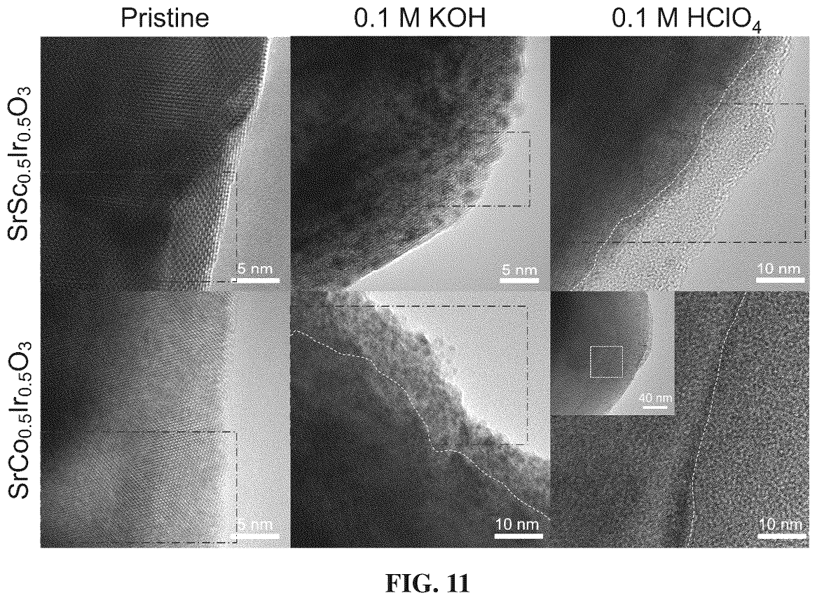

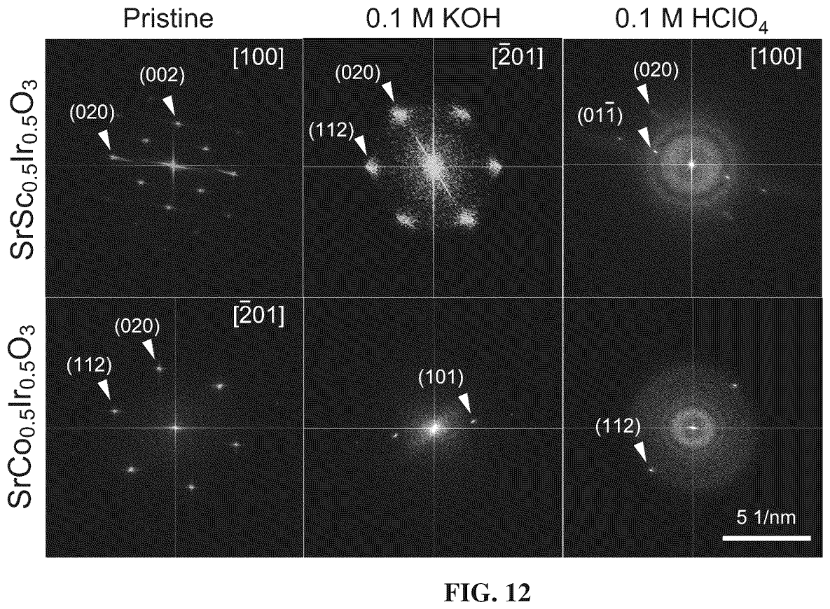

The local crystal structure of model perovskites was determined using high-resolution transmission electron microscopy (HR-TEM). As shown in FIG. 2c and FIG. 11, the HR-TEM images of the two pristine perovskites show a highly ordered atomic arrangement. The surface regions with the perovskite-type structure were further confirmed by indexing the corresponding Fast Fourier Transform (FFT) images with the XRD refinement results (FIG. 12).

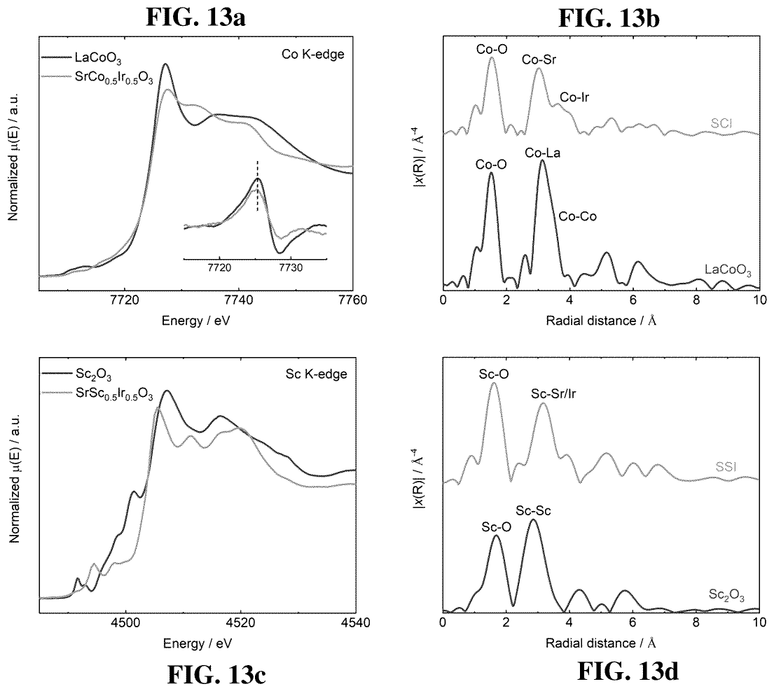

The initial states of Ir in the lattice of both perovskites were studied with X-ray absorption spectroscopy (XAS). As shown by FIG. 2d, the Ir Lₘ-edge (white lines) positions of SSI and SCI are close to each other but are ˜1.3 eV higher than those of Ir⁴⁺ in rutile IrO₂. Such position-shift is likely due to Ir being in a pentavalent state in SSI and SCI. Analyzing the K-edge spectra of Co and Sc (FIG. 13) confirms that both Co and Sc are in a perovskite structure. As shown in FIG. 13a, the positions of the white line from LaCoO₃ and SCI are close to each other, confirming that the trivalent Co is dominant in SCI. The Co is demonstrated in SCI perovskite structure as the featured peaks of Co—Sr and Co—Ir, related to SCI perovskite structure, can be identified in FIG. 13b. From the normalized Sc K-edge XANES spectra (FIG. 13c), the profile of Sc K-edge XANES spectra from SSI is much different from Sc₂O₃, hinting that Sc can be in a perovskite structure. This is because the profile of Sc K-edge XANES spectra is highly sensitive to the local structural environment. The Sc from SSI in a perovskite structure is further demonstrated by the corresponding EXAFS spectra of FIG. 13d where the Sc—Sr peak, related to the perovskite structure, can be observed.

For a better understanding of the electronic structure of Ir in perovskites, the second derivative of Ir Lₘ-edges spectra (white lines) of SSI and SCI are plotted in FIG. 2e. In the second-derivative curves of the two perovskites, two well-resolved peaks can be observed, while only one broad peak is found in IrO₂. The features of the Ir Lₘ-edge white lines are related to the electric dipole allowed transition from occupied 2p states to unoccupied 5d states. Therefore, the two peaks reflect the transitions from occupied 2p states of oxygen to the unoccupied t_{2g} and e_{g} orbitals of Ir⁵⁺ (LS, t_{2g}⁴e_{g}⁰), respectively. The observed similar characters of white lines of SSI and SCI indicate the electronic structures of Ir from both model perovskites are nearly the same.

The local structure environment around Ir in the lattice was studied based on the corresponding extended X-ray absorption fine structure (EXAFS) at the Ir Lₘ-edge (FIG. 2f). Three typical scattering peaks, with positions of ˜1.6, ˜3.0, and ˜3.6 Å, can be observed in the Fourier transform of the EXAFS spectra. The first peak denotes the Ir—O bond. The fitting of the first peaks (Table 3) shows that Ir in both perovskites is coordinated with six neighbor oxygen atoms, indicating that Ir is fully coordinated. The corresponding Ir—O bond lengths are 1.953±0.006 Å in SSI and 1.950±0.007 Å in SCI, both of which are close to the values (between 1.95 Å and 1.96 Å) reported for low-spin Ir⁵⁺ in other perovskites. J.-H. Choy, D. K. Kim, S. H. Hwang, G. Demazeau, D.-Y. Jung, XANES and EXAFS studies on the Ir—O bond covalency in ionic iridium perovskites. J. Am. Chem. Soc. 117, 8557-8566 (1995). The second and third peaks reflect the Ir—Sr and Ir—(Co, Sc) distance, respectively. Considering the right-shift of the second peak in SSI, a slightly larger Ir—Sr distance in SSI than that in SCI is expected, caused by the expansion of lattice volume, which increased from 240.80±0.01 Å³ for SCI to 254.59±0.01 Å³ for SSI (Table 2). Such lattice difference is related to the larger ionic size of Sc³⁺ (0.745 Å) than that of Co³⁺ (0.545 Å for low-spin and 0.61 Å for high-spin). Due to the strong overlap between the second and third peaks, such distance increment is indistinguishable from the third peak in SSI. The large Ir—(Co, Sc) distances (˜3.6 Å) observed in SSI and SCI confirm that the IrO₆ octahedron is corner-shared with the neighbor (Co, Sc) O₆ octahedron. The similar EXAFS spectra, obtained from the two model perovskites, indicate a nearly identical local structure environment for Ir. In other words, the fully-coordinated Ir⁵⁺O₆ octahedra are mono-p-oxo bridged to (Co, Sc) O₆ octahedra, constraining Sr (A-site cation) in a B-site cage.

TABLE 3
Fitting Parameters of the Fourier-Transformed
k³-Weighted Ir L_{III}-edge EXAFS (k-Range 3-12)

| | Ir—O (Å) | CN * | σ² (Å²) ** | ΔE₀ *** |
|---|---|---|---|---|
| SSI_pristine | 1.953(0.006) | 6.0(0.4) | 0.0011(0.0008) | 15.18(0.80) |
| SCI_pristine | 1.950(0.007) | 6.1(0.5) | 0.0016(0.0009) | 14.72(0.91) |
| SCI—H | 1.973(0.006) | 6.4(0.4) | 0.0041(0.0009) | 14.99(0.75) |
| IrO₂ | 1.983(0.005) | 6.0(0.4) | 0.0019(0.0006) | 14.13(0.63) |

* CN: Coordination number
** σ²: Debye-Waller factor.
*** ΔE₀: Energy shift

### B. Surface Reconstruction in Model Perovskites

Surface reconstruction of catalysts during electrochemical cycling usually is accompanied with gradually increased double-layer capacitance (DLC), intensity of redox peaks, and catalytic activity. The activity improvement is generally related to increased electrochemical area and/or the formation of a more active surface phase(s) after reconstruction. Cyclic voltammetry (CV) measurements were first used to understand the surface reconstructions of model perovskites.

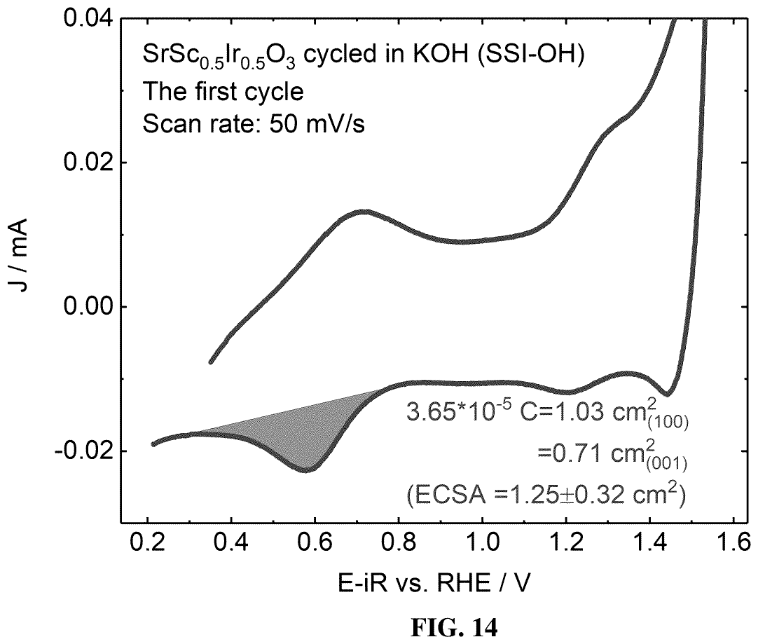

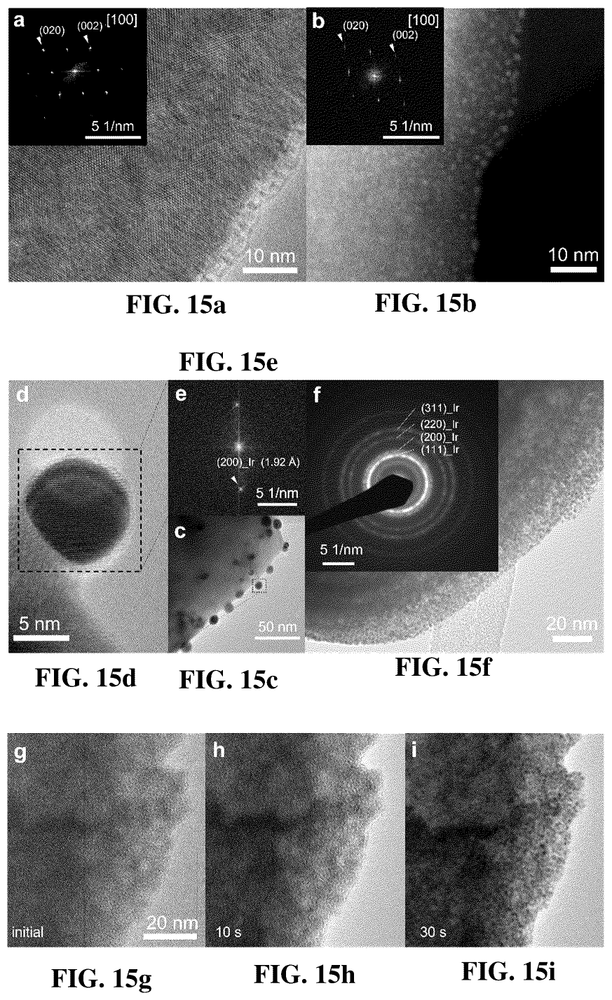

FIG. 3 summarizes the CV profiles of the model perovskites, which were cycled in either 0.1 M KOH or 0.1 M HClO₄. As shown by FIG. 3a, the activity of SrSc_{0.5}Ir_{0.5}O₃, cycled in an alkaline condition (SSI-OH), gradually decreases. The CV profiles (FIG. 3b) show an apparent redox peak at ˜0.6 V versus. RHE, which should be related to the Ir³⁺/Ir⁴⁺ redox transition. Importantly, only the Ir in the outer-surface contributes to this redox transition. This is supported by the integral charge of the cathodic peak at ˜0.6 V of the first CV cycle which is close to the charge (Ir⁴⁺ to Ir³⁺) estimated by assuming only the lattice Ir from the outer-surface of SrSc_{0.5}Ir_{0.5}O₃ is involved. More information is provided by FIG. 14.

Additional redox peaks above ˜1.2 V versus RHE are also observed. These peaks can be related to the redox transition of Ir⁴⁺/Ir⁵⁺, which occurs at high overpotentials. Interestingly, during the cycling tests, redox peak intensities and the OER current gradually decrease. In SSI, Sr²⁺ and Sc³⁺ have fixed oxidation states and therefore do not contribute to the redox peaks. Thus, the gradual disappearance of redox peaks in the CV indicates the loss of surface-active sites (Ir) in SSI. Although Ir can be one of the most stable elements, the highly oxidized Ir⁶⁺ (IrO₄²⁻) can be soluble. Thus, Ir in the outermost surface, which contributes to the measured OER catalytic activity, can dissolve during the cycling. Meanwhile, the DLC remains unchanged during the cycling, hinting that the surface of SSI can still be highly stable. According to the HR-TEM image of the SSI after the cycling (FIG. 3c, FIG. 11, and FIG. 12), the surface of SSI-OH is well crystallized. Some Ir nanoparticles evolved when performing TEM analysis likely due to the electron beam illumination, and the same phenomenon is also observed in SCI samples (FIG. 15). Apart from electron-beam induced formation of Ir nanoparticles, the reconstructed perovskite surfaces from SCI-OH, SSI-H, and SCI-H in this work are strictly amorphous.

IrO₂-related nanocrystallites form in five anodic cycles but disappear when the number of anodic cycles increases to 130. However, with similar electrochemical tests, the reconstructed surface of a polycrystalline monoclinic SrIrO₃ (with mixed edge-/corner-shared octahedrons) is strictly amorphous and no nanocrystallites can be observed. Given their identical composition, the substantial difference in crystal structure may account for the formation of reconstructed surfaces with different properties. This deduction is also supported by considering that the reconstructed Ir-based surface is more active if the IrO₆ octahedrons are corner-shared in the initial perovskite structure. IrO₆ octahedrons in the initial SCI and SSI compounds are also corner-shared. However, the IrO₂-related nanocrystallites cannot be found over the reconstructed surfaces perhaps because the presence of foreign B-site metals (Co and Sc) prohibits the evolution of rutile IrO₂.

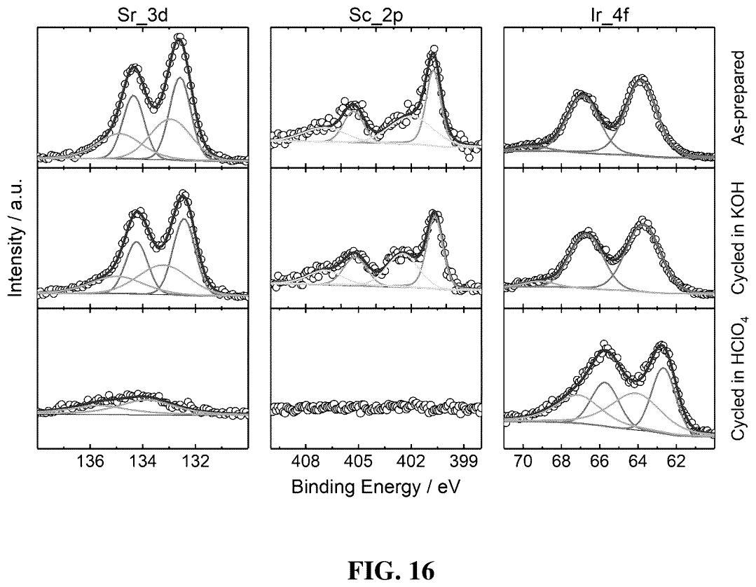

The stable surface of SSI-OH is further supported by XPS results (FIG. 16 and Table 4), in which the spectra of Sr_3d, Sc_2p, and Ir_4f from SSI-OH are close to the ones from pristine SSI. Therefore, the SSI cycled in alkaline conditions exhibits a stable surface structure. This corresponds well with the DFT prediction that the thermally unstable Sr is constrained in the SSI lattice in the alkaline condition.

TABLE 4
Fitting Parameters of the XPS Results from SrSc_{0.5}Ir_{0.5}O₃

| | SR* | | | | SC | | | | IR | | | |
|---|---|---|---|---|---|---|---|---|---|---|---|---|
| As prepared | 3d_{5/2} | 3d_{3/2} | 3d_{5/2} | 3d_{3/2} | 2p_{3/2} | 2p_{1/2} | 2p_{3/2} | 2p_{1/2} | 4f_{7/2} | 4f_{5/2} | satellite | |
| Peak | 132.6 | 134.4 | 133.1 | 134.9 | 400.7 | 405.3 | 402.0 | 406.5 | 63.9 | 66.9 | 69.5 | / |
| position | | | | | | | | | | | | |
| FWHM | 0.98 | 0.98 | 2.22 | 2.22 | 0.99 | 1.36 | 2.97 | 3.51 | 1.92 | 1.99 | 2.15 | |
| Cycled in KOH | 3d_{5/2} | 3d_{3/2} | 3d_{5/2} | 3d_{3/2} | 2p_{3/2} | 2p_{1/2} | 2p_{3/2} | 2p_{1/2} | 4f_{7/2} | 4f_{5/2} | satellite | |
| Peak | 132.5 | 134.2 | 133.3 | 135.0 | 400.7 | 405.2 | 402.5 | 406.91 | 63.7 | 66.7 | 69.1 | / |
| position | | | | | | | | | | | | |
| FWHM | 1.03 | 1.03 | 2.42 | 2.42 | 1.08 | 1.54 | 2.11 | 2.36 | 2.13 | 2.04 | 1.85 | |
| Cycled in HClO₄ | 3d_{5/2} | 3d_{3/2} | | | | | | | 4f_{7/2} | 4f_{5/2} | 4f_{7/2} | 4f_{5/2} |
| Peak | 133.9 | 135.7 | / | | / | | | | 62.7 | 65.7 | 64.1 | 67.1 |
| position | | | | | | | | | | | | |
| FWHM | 2.52 | 2.72 | | | | | | | 1.48 | 1.69 | 3.11 | 2.83 |

*Considering the spin-orbit splitting, a relative area ratio of 2:3, 1:2, and 3:4 is considered for the doublets in Sr_3d, Sc (Co)_2p, and Ir_4f, separately. Spin-orbit splitting of 3 eV is considered for the doublets in Ir_4f. A Shirley background was applied during the fitting. All peaks are described as the convolution of Gaussian and Lorentzian functions.

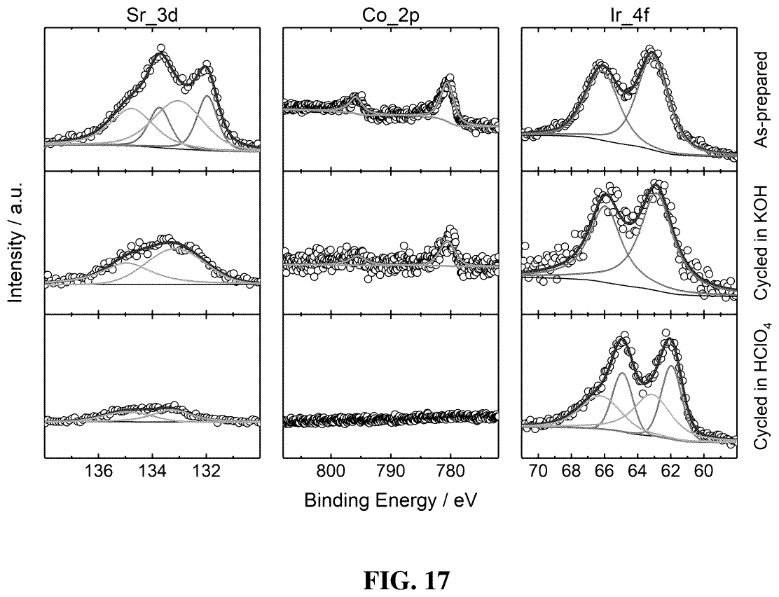

FIGS. 3d and 3e are SrCo_{0.5}Ir_{0.5}O₃ CVs in an alkaline condition (SCI-OH). The activity slowly increases in the initial 25 cycles and maintains constant in the following cycles. The CV profile in the initial 5 cycles resembles that for SSI-OH. However, in the 25^{th} CV cycle, several distinctive oxidation peaks between 0.9 and 1.3 V are observed, and the peaks become more pronounced in the 50^{th} CV cycle. Due to the existence of the Co^{3/4+} redox transition, it is difficult to distinguish the contribution of Ir and Co to the redox peaks. Nevertheless, the irreversible redox features and gradually increased DLC during cycling hint that surface reconstruction occurs during cycling. From the corresponding HR-TEM images (FIG. 3f, FIG. 11, and FIG. 12), the SCI-OH surface loses the long-range ordered perovskite structure and is amorphous with a depth of approximately 10 nm. XPS spectra (Sr_3d, Co_2p, and Ir_4f in FIG. 17 and Table 5) also confirm the surface reconstruction. With Ir as a reference, ˜35% Sr has dissolved from the amorphous surface. Considering the observed stable SSI-OH surface, the reconstruction of the SCI-OH surface is switched on by replacing B-site Sc with thermodynamically unstable Co. The reconstruction process appears to involve (1) slight leaching of B-site Co triggers the massive leaching of Sr; (2) the perovskite structure cannot sustain such a high degree of A-site deficiency; (3) the surface loses the long-range ordering and becomes amorphous.

TABLE 5
Fitting Parameters of the XPS Results from SrCo_{0.5}Ir_{0.5}O₃

| | SR | | | | CO | | IR | | | |
|---|---|---|---|---|---|---|---|---|---|---|
| As prepared | 3d_{5/2} | 3d_{3/2} | 3d_{5/2} | 3d_{3/2} | 2p_{3/2} | 2p_{1/2} | 4f_{7/2} | 4f_{5/2} | | |
| Peak | 132.0 | 133.7 | 132.9 | 134.7 | 780.6 | 795.9 | 63.1 | 66.2 | / | |
| position | | | | | | | | | | |
| FWHM | 0.82 | 0.82 | 2.5 | 2.5 | 2.68 | 2.68 | 2.21 | 2.42 | | |
| Cycled in KOH | 3d_{5/2} | 3d_{3/2} | | | 2p_{3/2} | 2p_{1/2} | 4f_{7/2} | 4f_{5/2} | | |
| Peak | 133.1 | 134.7 | / | | 780.6 | 795.6 | 62.9 | 66.0 | / | |
| position | | | | | | | | | | |
| FWHM | 2.78 | 2.45 | | | 3.15 | 3.15 | 2.41 | 2.31 | | |
| Cycled in HClO₄ | 3d_{5/2} | 3d_{3/2} | | | | | 4f_{7/2} | 4f_{5/2} | 4f_{7/2} | 4f_{5/2} |
| Peak | 133.4 | 135.2 | / | | / | | 62.0 | 64.9 | 63.1 | 66.2 |
| position | | | | | | | | | | |
| FWHM | 1.98 | 1.98 | | | | | 1.45 | 1.43 | 2.74 | 2.90 |

In low pH-value solutions, Sc is thermodynamically unstable (FIG. 7). The surface of SSI is expected to be unstable in acidic conditions. FIG. 3g shows the CVs of SrSc_{0.5}Ir_{0.5}O₃ measured in 0.1 M HClO₄ (SSI-H). The activity of SSI-H steeply increases in the initial 5 cycles, indicating the surface of SSI-H experiences reconstruction. As shown by FIG. 3h, a distinctive oxidation peak at ˜1.45 V can be observed in the first cycle. This peak disappears from the 2^{nd} cycle. The irreversibility and high intensity indicate that this oxidation peak is related to the fast dissolution of cations. In the following cycles, apparent increases of the redox peaks' intensity and DLC are observed, indicating more redox-active sites are available. From the HR-TEM image of SSI-H (FIG. 3i, FIG. 11, and FIG. 12), an amorphous surface region, with a depth of ˜10 nm, is observed. However, in contrast to the amorphous surface observed from SCI-OH, the XPS analysis confirms that a larger amount of Sr (˜80 wt. %) and almost all Sc have been leached from the surface of SSI-H (FIG. 16), which leads to the formation of an Ir-rich amorphous surface.

The CV profiles of SrCO_{0.5}Ir_{0.5}O₃ cycled in acid (SCI-H) are shown in FIGS. 3j& k. Similar to the case of SSI-H, a gradually increased activity is observed in the initial 25 cycles. The steeply increased DLC and intensity of redox peaks highlight a heavy surface reconstruction. Interestingly, after cycling, the profile of the final CV resembles the one of SSI-H, indicating a similar reconstructed surface may form over SCI-H. This is reasonable, given that the initial state of Ir in SSI and SCI are nearly identical to each other. The corresponding TEM images (FIG. 3I, FIG. 11, and FIG. 12) show that the surface of SCI-H is also amorphous after the surface reconstruction. The depth of the amorphous region can reach ˜50 nm in 50 CV cycles, which is much deeper than those observed in SCI-OH and SSI-H. Such conspicuous surface reconstruction can be correlated with the heavy cation (Sr and Co) leaching, as evidenced by the absence of XPS signals of Sr_3d and Co_2p in SCI-H (FIG. 17).

The surface composition changes of all four samples are summarized in FIG. 3m and a schematic illustration (FIG. 3n) presents the surface status in all four cases. The first schematic shows that the surface of SSI-OH maintains the perovskite structure. The second one illustrates that the surface of SCI-OH is amorphous, but the leaching is relatively light, and A-site Sr cations are partially leached out. The third one shows that the surface of SSI-H is amorphous, and the surface region is Ir-rich. A high proportion of A-site Sr and almost all B-site Sc are leached out. The last one is for SCI-H, where the vast majority of Sr and almost all B-site Co atoms have been leached from the surface. The measured activity of SSI-OH is mainly contributed by the Ir in the perovskite lattice, but the activities measured in the other three cases are most likely contributed by the Ir from the reconstructed perovskite surfaces.

### C. Activity Evolution During Surface Reconstruction

To highlight the promoting effect of surface reconstruction for OER, the geometry-surface-area-normalized (GEO-normalized) activities of SSI-OH, SCI-OH, SSI-H, and SCI-H are shown in FIG. 4a. The inset shows the GEO-normalized OER currents at 1.5 V versus RHE. Clearly, although the initial perovskite structures of the four samples are similar, the GEO-normalized activities of SCI-OH, SSI-H, and SCI-H, which undergo surface reconstruction under OER, greatly outperform the activity of SSI-OH. Specifically, at 1.5 V vs. RHE, the GEO-normalized OER current of SCI-H (j_{geo}=7.5 mA cm⁻²) is approximately 20 times higher than that of SCI-OH (j_{geo}=3.5 mA cm⁻²) and 150 times higher than that of SSI-OH (j_{geo}=0.05 mA cm⁻²). The activity improvement is likely caused by two features during surface reconstruction. The first is the reconstruction of the perovskite surface from crystalline (SSI-OH) to amorphous (SCI-OH) with A-site cation (Sr) leaching. Such reconstruction induces an activity improvement of approximately one order of magnitude. The second is the additional leaching of B-site cations, which induces further activity improvement (SCI-OH vs. SCI-H) of approximately one order of magnitude. The surface reconstruction of perovskites, including both the A-site and B-site cation leaching, is the key for the measured high activity. Nonetheless, where surface reconstruction occurs, the GEO-normalized activity may not precisely reflect the intrinsic activity of the reconstructed surfaces. This is because that the real active area may increase during the surface reconstruction, as reflected by the steeply increased DLC during electrochemical cycling (FIG. 3). In this case, the current density normalized by electrochemical surface area (ECSA) is more suitable to represent the intrinsic activity of the model perovskites.

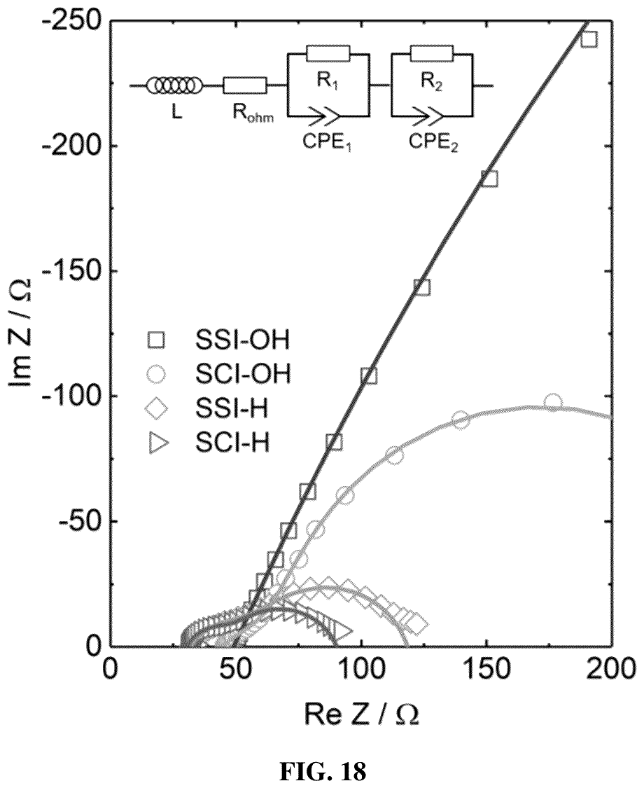

The ECSA was estimated using advanced impedance spectrum analysis. More information is provided with reference to FIG. 18 and FIG. 19. In FIG. 4b, the intrinsic OER current densities versus potential are plotted, and the intrinsic OER current density from an IrO₂(110) film is also plotted for comparison. The intrinsic activity of SSI-OH is much closer to the reported OER activity of a SrIrO₃ perovskite film with a stable surface in alkaline, confirming that the measured activity originates from Ir in the perovskite lattice. On the other hand, the intrinsic current of SCI-OH is close to that of SSI-OH without surface reconstruction, suggesting that the initial surface reconstruction with only A-site Sr leaching contributes little to the intrinsic activity improvement. Such surface reconstruction, however, generates more electrochemical areas available for OER, which explains the measured higher GEO-normalized activity of SCI-OH (FIG. 4a). More than one order of magnitude improvement in intrinsic activity is observed in SSI-H and SCI-H, which both experience additional B-site cation leaching. The steeply increased intrinsic activity indicates that certain highly active Ir sites are formed in the thoroughly reconstructed surfaces (SSI-H and SCI-H after 50 CV cycles).

### D. Calculation of ECSA with EIS

Representative impedance spectra from SSI-OH, SCI-OH, SSI-H, and SCI-H are provided by FIG. 18. The tests were performed at a potential of 1.5 V versus RHE. Specifically, during CV tests, corresponding electrochemical impedance measurements were conducted at the beginning (after 2 CV cycles) for SSI-OH and after 50 CV cycles for SCI-OH, SSI-H, and SCI-H. This is because the OER current in the initial SSI-OH CV cycles originated from the near-ideal SSI perovskite surface, whereas the OER currents in the final CV cycles of the other three samples originated from the fully reconstructed surface. The FIG. 18 inset is the equivalent circuit (LRₒₕₘ(R₁//CPE₁)(R₂//CPE₂)) for identifying the charge transfer process and diffusion process. The Land Rₒₕₘ represent the inductance and ohmic resistance of the testing system, respectively. The parallel R₁//CPE₁ and R₂//CPE₂ correspond to the charge transfer process and diffusion process, respectively. Specifically, in the charge transfer process, the R₁ is the charge transfer resistance and the CPE₁, a constant phase element, is used in place of a capacitor to compensate for non-homogeneity in the system. The CPE can be expressed as

$${Z}_{CPE} = \frac{1}{T ( Iw ) \hat{} P}$$

Where T is a frequency-independent constant with F [symbol] ^{(P-1)}ₘ⁻² units, I is the square root (−I),
w is the angular frequency of the AC signal, and P is a parameter ranging from 0 to 1. The electrochemical double-layer capacitance can be obtained with the equation of

$$C = {( {T ( \frac{1}{{R}_{ohm}} + \frac{1}{{R}_{1} + {R}_{2}} )}^{P - 1} )}^{1 / P}$$

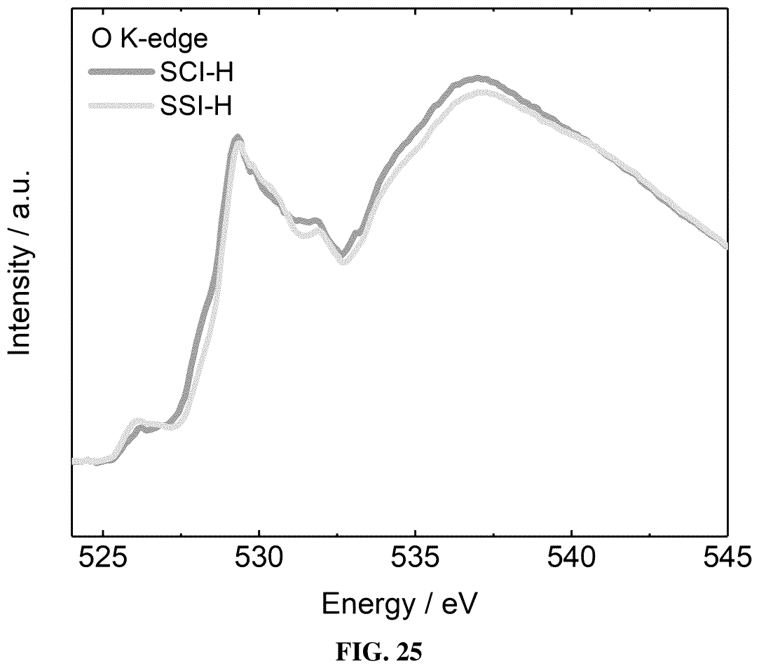

The electrochemical surface area can be calculated with

$$E C S A = \frac{C}{{C}_{s}}$$

Where Cₛ is the specific capacitance of the sample. In FIG. 4b, a typical specific capacitance of 0.4 F m⁻² was used to estimate the ECSA for SSI-OH, SCI-OH, SSI-H, and SCI-H. This value is an average specific capacitance derived from reported specific capacitances of various metallic surfaces. The estimated ECSA based on this typical specific capacitance for activity normalization can be fairly reliable. This specific capacitance is demonstrated proper for SSI-OH with a stable surface because the estimated ECSA is close to the area estimated with redox charge (FIG. 14). For SCI-OH, SSI-H, and SCI-H with reconstructed amorphous surfaces, a similar specific capacitance is expected. For instance, with the standard specific capacitance of 0.4 F m⁻², the normalized OER current densities of SSI-H and SCI-H are close to each other (FIG. 4b). This corresponds well with the conclusion that a similar phase is formed over their reconstructed surfaces (FIG. 25). Nevertheless, for SCI-OH, SSI-H, and SCI-H with reconstructed surfaces, using such a specific capacitance of 0.4 F m⁻² may induce an under-or an over-estimated intrinsic activity. Based on the literature reports, the specific capacitance of metal electrodes can change from 0.15 F m⁻² to 1.1 F m⁻² in H₂SO₄ and from 0.22 F m⁻² to 1.3 F m⁻² in NaOH and KOH electrolytes. Rutile IrO₂ has a specific capacitance of 1.3 F m⁻². Thus, the ECSA-normalized OER current densities with the consideration of specific capacitance variation (FIG. S13) were also checked. For SCI-OH, specific capacitances from 0.22 F m⁻² to 1.3 F m⁻² are considered. For SSI-H and SCI-H, specific capacitances from 0.15 F m⁻² to 1.1 F m⁻² are considered.

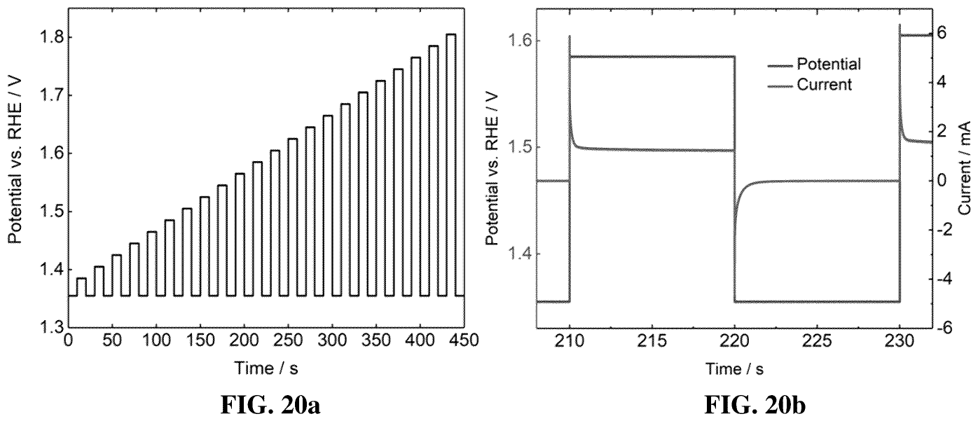

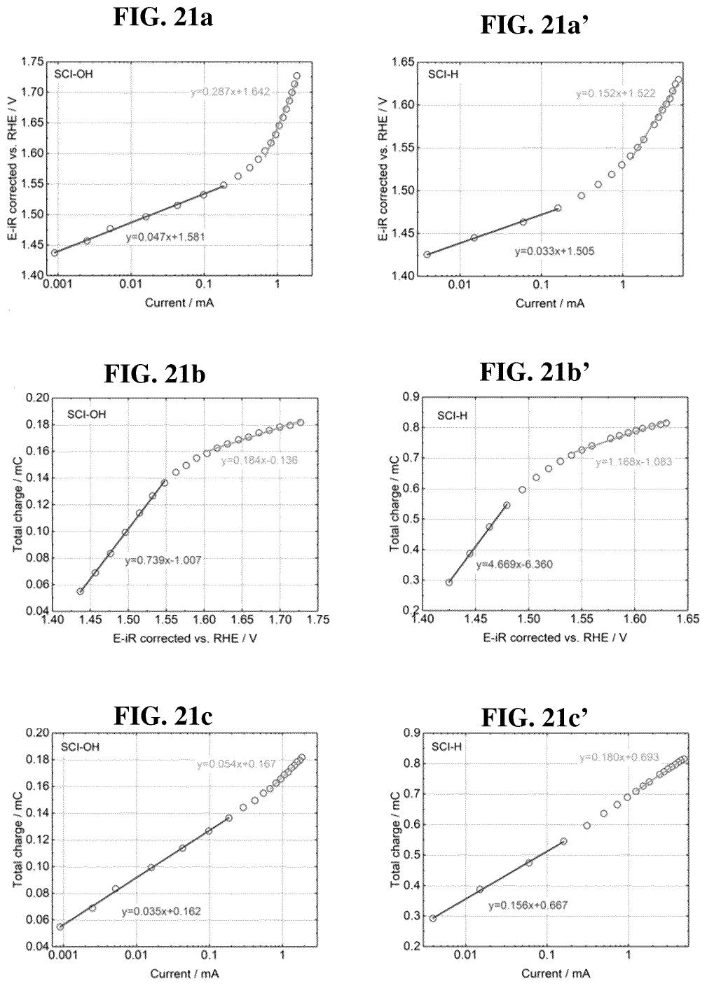

Interestingly, all Tafel plots for the three surface-reconstructed catalysts SCI-OH, SSI-H, and SCI-H exhibited prominent “bending” behavior with a change of Tafel slope from ˜40 mV/dec at low potentials to ˜100 mV/dec at high potentials. Specifically, the Tafel plot of SCI-OH shows a bending at a potential of ˜1.53 V, while the bending of Tafel plots from SSI-H and SCI-H starts at a lower potential of ˜1.49 V. More recently, a universal linear relationship between log (current) and pseudocapacitive charge storage (catalyst deprotonation with hole formation) has been demonstrated for rutile IrO₂. The observed bending of Tafel plot at ˜1.58 V is related to the change in the response of IrO₂ surface hole coverages to the potential applied. With pulse voltammetry tests, the logarithm of OER current from SCI-OH and SCI-H was also proportional to the corresponding charge stored during OER (FIGS. 20 and 21). The observed lower bending potential (below 1.50 V) indicates that the deprotonation behavior over a fully reconstructed perovskite surface is different from that for rutile IrO₂, hinting the unique local environment of active Ir sites in the reconstructed perovskite surfaces.

To further confirm that the high intrinsic activity is related to the formation of superior Ir sites, the turnover frequencies (TOF) of Ir from different surfaces were calculated by taking structural effects (the arrangement of surface Ir atoms) into account. Based on well-defined surfaces, the overpotentials required to reach a TOF of 0.03 s⁻¹ are compared in FIG. 4c. The overpotential required for SSI-H and SCI-H are between 250-263 mV, and they are ˜170 mV and ˜60 mV lower than IrO₂ (428 mV) and SCI-OH (308-315 mV), respectively. This overpotential reduction corresponds well with the measured increment of the intrinsic activity during the surface reconstruction process (FIG. 4b), confirming that the observed high intrinsic activity is due to the formation of highly active Ir. Moreover, the activity evaluation also reveals that leaching of B-site cations forms highly active Ir in the reconstructed perovskite surface. That is, highly active Ir in a reconstructed perovskite surface can only be activated when the B-site cations (Sc/Co), those adjacent to the Ir, are leached out.

### E. The State of Active Ir-Site in the Reconstructed Surface

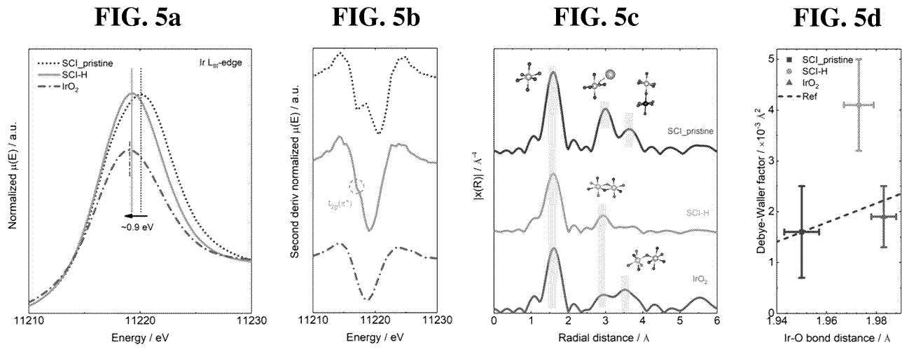

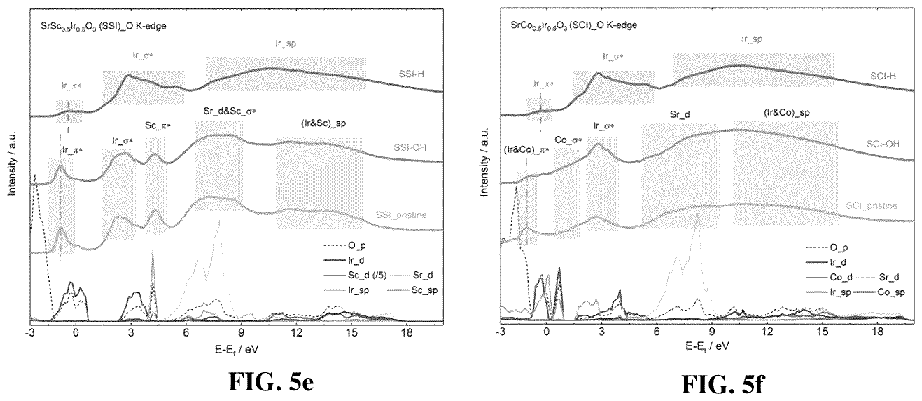

To better understand the structure of the reconstructed surface, especially the formed highly active Ir, the local structure and oxidation state of Ir in the reconstructed surface region were characterized by XAS using total-electron-yield (TEY) detection. SCI-H, which has a fully reconstructed surface, was used as a model sample. FIG. 5a shows the Ir Lₘ-edge spectrum of SCI-H. The Ir Lₘ-edge spectra should originate from the highly active Ir sites in the reconstructed surface since the XAS in TEY mode is more surface-sensitive due to the short escape depth of electrons. The Ir Lₘ-edge spectra of pristine SCI and IrO₂ are also presented. As compared with the white line position of Ir⁵⁺ in pristine SCI, the white line position of Ir Lₘ-edge spectra from the reconstructed surface region shifts left and is close to the white line position of Ir⁴⁺ in IrO₂, indicating the tetravalent state of Ir in the reconstructed surface. The corresponding energy shift is ˜0.9 eV, which is close to the reported energy shift of 0.8˜1 eV for a unit change of the Ir oxidation state. FIG. 5b shows the second derivatives of Ir Lₘ-edge spectra. As compared with the pristine SCI, the second derivative of Ir Lₘ-edge spectra from the reconstructed perovskite surface shows a weak peak splitting due to the splitting of d-orbitals. Besides, the relative intensity of the peak, which is related to the transition to the t_{2g} orbital, becomes much lower. This should be caused by the reduction of initial Ir⁵⁺ (t_{2g}⁴e_{g}⁰) to Ir⁴⁺ (t_{2g}⁵e_{g}⁰), which has almost fully filled t_{2g} orbital after surface reconstruction.

The local structural environment of Ir in the reconstructed SCI-H surface was then studied by EXAFS. FIG. 5c shows the Fourier-transformed k³-weighted Ir Lₘ-edge EXAFS of pristine SCI, rutile IrO₂, and SCI-H. From the spectrum of SCI-H, the two peaks for Ir—Sr (˜3.0 Å) and Ir—Co (˜3.6 Å) bonds in perovskite structure disappear, indicating the initial perovskite structure no longer exists in the SCI-H surface region. Instead, a new peak with a reduced distance of ˜2.9 Å appears. Compared with the spectrum of rutile IrO₂, such a peak is caused by the di-u-oxo bridged IrO₆ octahedra. That is, although the reconstructed SCI surface is amorphous, a large amount of edge-sharing IrO₆ octahedra appear after the surface reconstruction.

On the other hand, the typical peak reflecting corner-shared IrO₆ octahedra in rutile IrO₂ does not appear in the spectrum of SCI-H. The additional fitting of the first peak revealed that the Ir center in the reconstructed SCI surface is fully coordinated with six oxygen atoms (Table 3). However, due to the reduction of Ir5+after surface reconstruction, the average Ir—O bond length increases to 1.973 Å, which is higher than 1.950 Å in pristine SCI but comparable to that in rutile IrO₂ (1.983 Å). In addition to the bond length, the Debye-Waller (DW) factor, which corresponds to the mean-square-displacement of the Ir—O bond length due to the vibration and/or the static disorder, can be obtained from the fitting. For the vibration, a longer Ir—O bond length with stronger thermal vibration should induce a larger DW factor. As a result, a positive correlation between Ir—O bond length and DW factor has been found in Ir-based perovskites (the dashed line in FIG. 5d). For the static disorder, both local structural defects (coordinatively unsaturated sites) and multiple bond lengths (highly distorted IrO₆ octahedra) can also induce a high DW factor. As shown by FIG. 5d, the Ir—O bond lengths and DW factors of pristine SCI and rutile IrO₂ are in accordance with the reported positive correlation. Nevertheless, a much higher DW factor is estimated from the fitting results of the reconstructed SCI-H surface. Considering that the Ir in the reconstructed surface is fully coordinated, the large DW factor reveals that the IrO₆ octahedra in the reconstructed SCI surface are highly distorted. Such multiple Ir—O bond lengths can be explained by the fact that Ir should bond with O, OH, and even OH₂ after surface reconstruction.

Soft XAS (in TEY mode) characterization at the O K-edge was performed to better assess the effect of surface reconstruction on the local electronic state of Ir. As a result of the low energy of soft X-ray, the probing depth of soft X-ray in TEY mode is around a couple of nanometers. This makes the O K-edge spectrum highly sensitive to the surface. Because the unoccupied oxygen 2p band hybridizes with the unoccupied metal bands, the O K-edge spectrum can reflect the surface electronic structure changes before and after reconstruction.

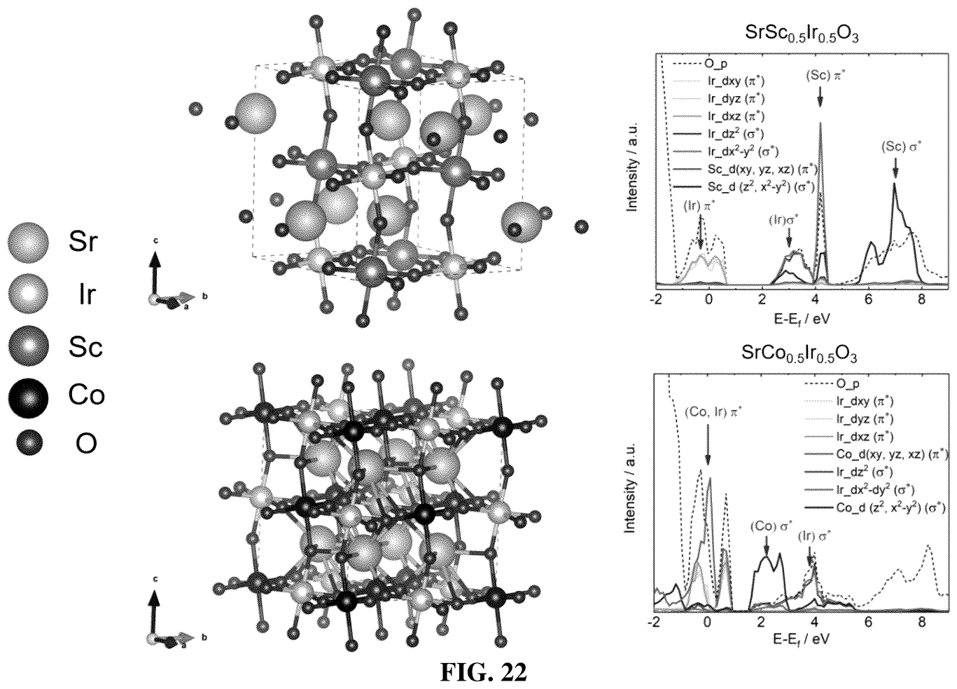

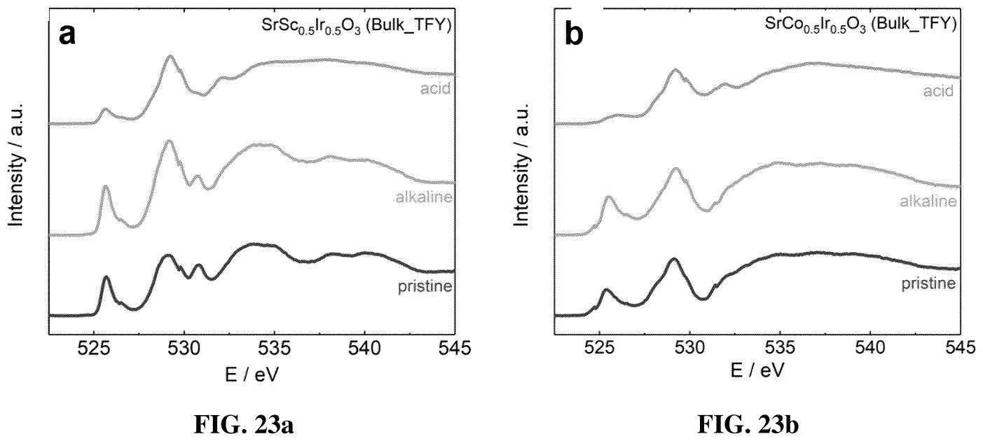

FIGS. 5e and 5f are the O K-edge spectra of the pristine and electrochemically cycled perovskites. The O K-edge spectra of the pristine perovskites can be well indexed with the calculated electronic structures (Ir_d and O_p). Additional details of the calculated electronic structures are shown in FIG. 22. In brief, the broad shoulders above ˜5 eV are related to the hybridization of O_p, Sr_d (A-site), and Ir/Co/Sc_sp (B-site). The featured pre-edge peaks correspond to the O_p states hybridizing with t_{2g} (π*) and e_{g} (σ*) states of the B-site cations (Ir, Co, and Sc). Moreover, the O K-edge spectra of the surfaces of pristine perovskites (FIGS. 5e and 5f) also resemble the spectra of the corresponding bulk materials (FIG. 23), confirming the perovskite structures of the initially crystallized surfaces. In FIG. 5e, the spectra of the pristine SSI and SSI-OH are almost identical to each other, confirming the surface of SSI is highly stable when cycled in alkaline. Unlike SSI-OH, the O K-edge spectrum of the SCI-OH changes, indicating surface reconstruction occurs in alkaline (FIG. 5f). Nevertheless, all the features related to pristine perovskite SSI and SCI disappear in the spectra of SSI-H and SCI-H.

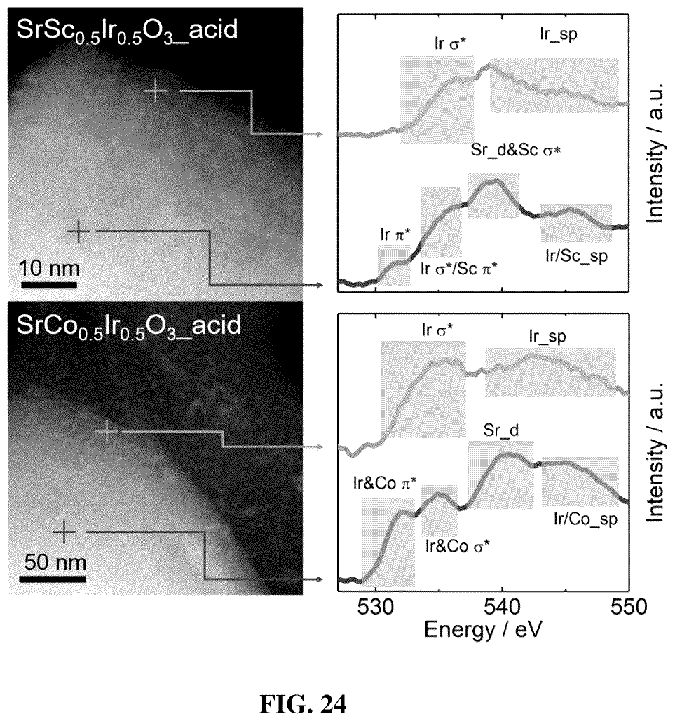

Similar changes can be also observed in the O K-edge spectra of the STEM-EELS analysis (FIG. 24). The disappearance of these features indicates that thoroughly reconstructed surfaces are formed after cycling in acid.

The observed evolution of O K-edge spectra corresponds well with the detected surface reconstructions in SSI and SCI (FIG. 3). Importantly, both O K-edge spectra of the reconstructed surfaces of SSI-H and SCI-H resemble each other (FIG. 25), hinting that the two reconstructed surfaces have nearly identical electronic structures. Thus, the active sites (local domains with short-range order) in the reconstructed amorphous perovskite surfaces can be akin to certain IrOₓH_{y} phases with a well-defined crystal structure. Additionally, the measured O K-edge spectra can be considered as a fingerprint for identifying the possible structure.

### F. Likely Structure of the Reconstructed Perovskite Surface

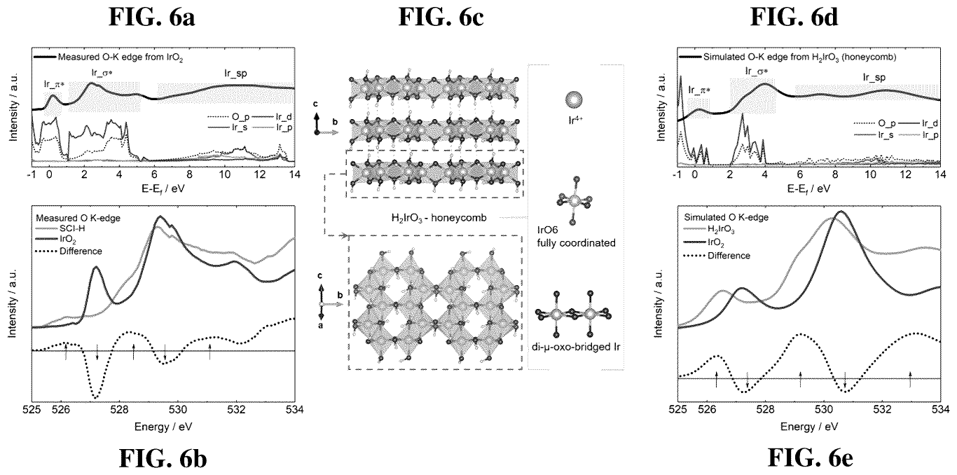

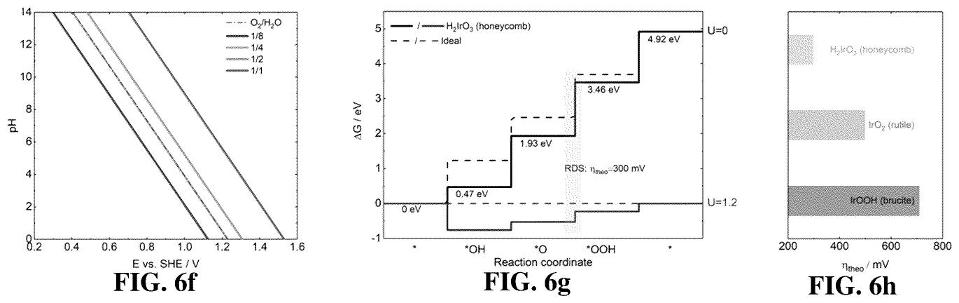

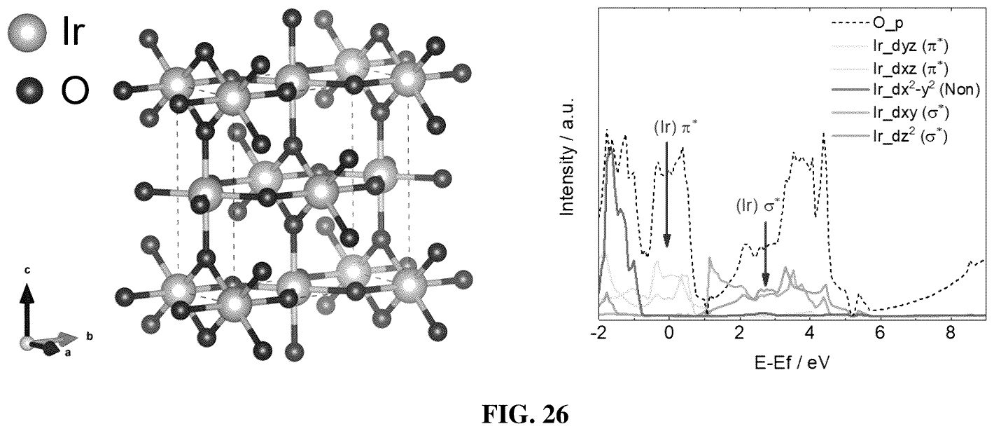

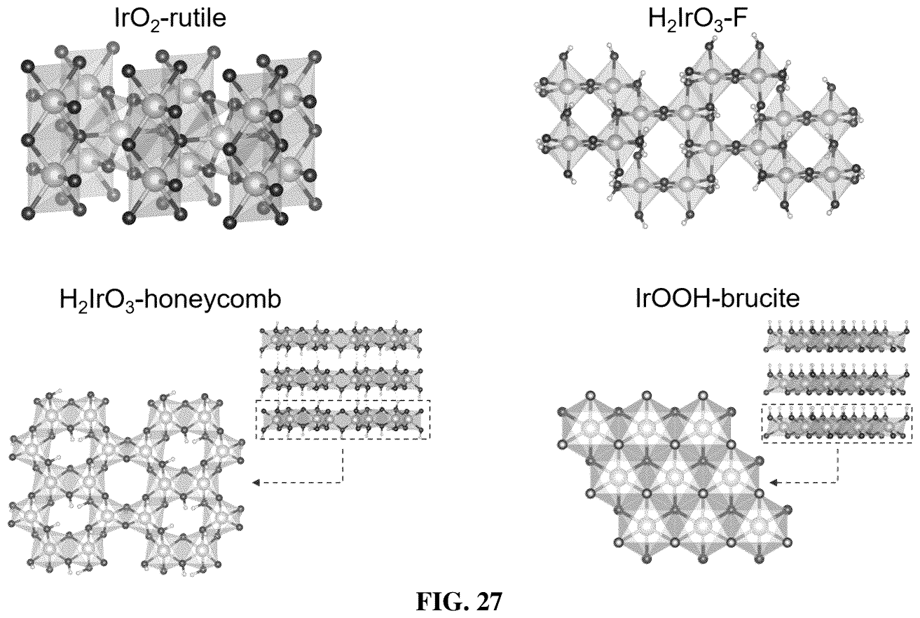

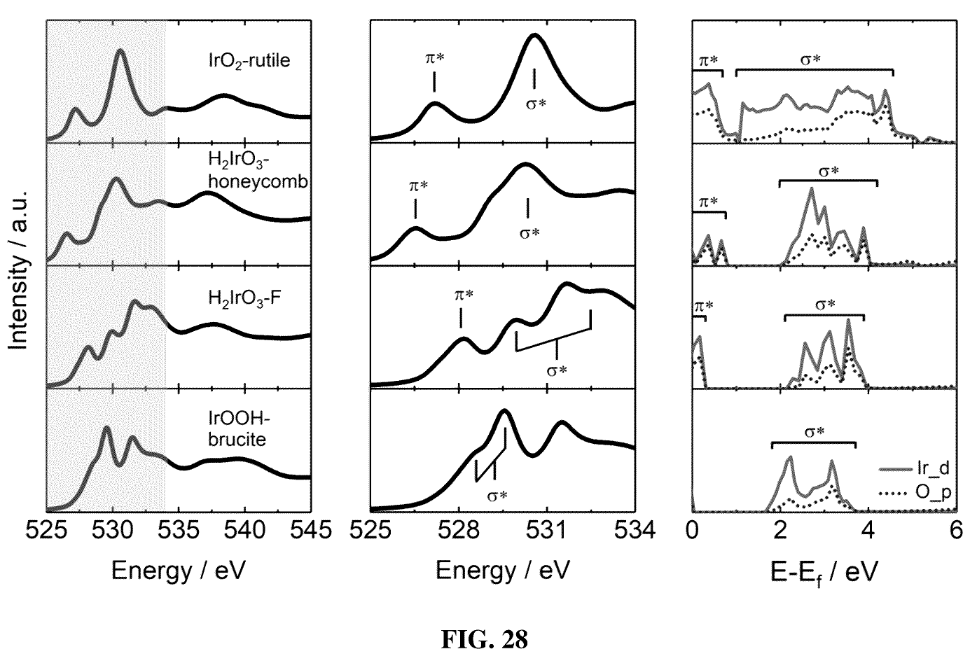

To explore the most likely structure of the IrOₓH_{y} phase in the reconstructed perovskite surface, the O K-edge spectrum of rutile IrO₂ was measured and compared to that of SCI-H with a reconstructed surface. As shown by FIG. 6a and FIG. 26, the O K-edge spectra of rutile IrO₂ have three parts, which are related to the hybridization of O_p with Ir_d(π*), Ir_d(σ*), and Ir_sp, respectively. The featured pre-edge peaks of the two O K-edge spectra and the corresponding difference are shown by FIG. 6b. Compared to the O K-edge spectra of IrO₂, in the spectrum of SCI-H, the Ir(π*) peak is flatter and shifts ˜1 eV to lower energy, while the Ir (σ*) peak resembles that of IrO₂. Based on the results of XAS analysis (FIGS. 5a-5d), a series of possible Ir-based oxides (FIG. 27) are proposed, whose O K-edge spectra were simulated with the consideration of the core-hole effect (FIG. 28).

As displayed in FIG. 6c, the states of Ir and O in H₂IrO₃ with layered honeycomb structure match well with the characteristics of the reconstructed perovskite surface. Specifically, in this honeycomb structure, the Ir⁴⁺ ions are fully coordinated with six oxygen atoms, and the IrO₆ octahedra are strictly edge-sharing. The simulated O K-edge spectrum of the honeycomb structure and the corresponding density of states are presented by FIG. 6d. Three parts, corresponding to the contributions from Ir_d(π*), Ir_d(σ*), and Ir_sp, can be identified from the spectrum. The pre-edge peaks in this spectrum are compared with the simulated pre-edge peaks of rutile IrO₂ (FIG. 6e). Importantly, the difference between the simulated O K-edge spectra from H₂IrO₃ and IrO₂ resembles the measured difference shown in FIG. 6b, indicating that the structure of the active site in the amorphous perovskite surface is close to this simulated honeycomb structure.

Note that, if the honeycomb character is ignored, the structure of H₂IrO₃ is similar to those of transition-metal-(oxy) hydroxides, which are also popular OER catalysts. Additionally, the formation of certain (oxy) hydroxide(s) that feature edge-sharing octahedra has also been considered as the real active phase(s) of some highly active complex oxides with surface reconstruction. On the other hand, a layered IrOOH has also been synthesized for catalyzing OER, but the activity of this IrOOH is reported to be inferior to the rutile IrO₂. Considering that the intrinsic activity of the Ir (oxy) hydroxide(s) in the amorphous perovskite surface is superior to both rutile IrO₂ and perovskite SSI (FIG. 4b, FIG. 4c), the identified honeycomb structure should be the intrinsic reason for the high activity. Complementary DFT calculations were performed to explore the surface properties of H₂IrO₃ (honeycomb).

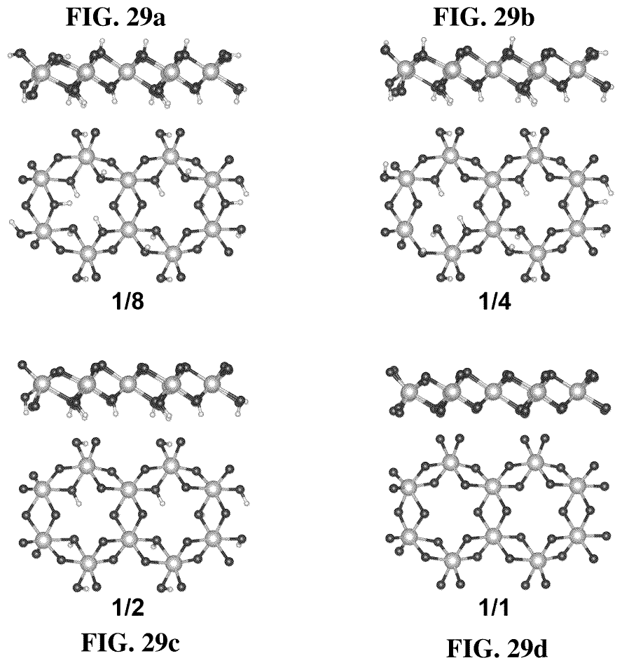

Considering the unusual Tafel plot bending (FIG. 4b and FIG. 21), the surface deprotonation behavior versus potential in the honeycomb H₂IrO₃(FIG. 6f and FIG. 29) was first simulated. As compared with the reported case over rutile IrO₂ surface, the desorption of protons in the honeycomb H₂IrO₃ is much more sensitive to the potential applied. For instance, ½ surface protons are ready to desorb at a potential of 1.308 V (versus RHE), while a potential of ˜1.45 V is expected for rutile IrO₂. Then, the lower potential of Tafel plot bending in the honeycomb H₂IrO₃ can be ascribed to the corresponding unusual surface deprotonation behavior.

Additionally, the OER free energy diagrams were also computed to investigate the thermodynamic features of H₂IrO₃. As shown by FIG. 6g, the rate-determining OER step of H₂IrO₃ is the elementary step to oxidize *O to an *OOH state, which requires a potential of 1.53 V (versus RHE) to initiate the reaction. The free energies of *OH and *OOH fit well with the established scaling relation in perovskite and rutile, further supporting that the reconstructed honeycomb structure is strictly composed of edge-sharing IrO₆ structural units. FIG. 6h compares the computed reaction overpotential of IrO₂, IrOOH, and H₂IrO₃. In accordance with the reported experimental result, the layered IrOOH has an even higher overpotential than rutile IrO₂, suggesting that the reconstructed surface can hardly be in an intact and layered Ir (oxy) hydroxide phase. In contrast, the honeycomb H₂IrO₃ shows a much lower overpotential than IrO₂, further supporting the high likelihood of its role in contributing to the high activity of the reconstructed surface.

Reconstruction-induced activity improvement for compounds disclosed herein is likely due to two factors. First, the surface reconstruction with A-site metal cation leaching makes more electrochemical area available for OER. The second is the formation of a highly active IrOₓH_{y} phase in thoroughly reconstructed surfaces with mixed A-site and B-site metal cation leaching, and the B-site cation leaching is pivotal to the formation of such an active phase. Subsequently, with surface-sensitive O K-edge spectra as fingerprints, the active phase possesses a honeycomb-like structure, which is responsible for the high activity. The activity of SCI-H after surface reconstruction is among the best toward water oxidation in acid. Given that surface reconstruction with ion leaching has been intensively observed in the catalysts for electrocatalysis, the step-by-step leaching strategy disclosed herein can be extended to other complex catalysts to investigate the roles of element leaching in surface reconstruction processes for better catalyst design.

### V. EXAMPLES

The following example is provided to illustrate certain features of the present invention. A person of ordinary skill in the art will appreciate that the scope of the invention is not limited to the features of this particular example.

### Example 1

This example concerns the synthesis of model perovskites. Both SrCo_{0.5}Ir_{0.5}O₃ and SrSc_{0.5}Ir_{0.5}O₃ were synthesized using a solid-state reaction. Stoichiometric amounts of SrCO₃ (Sigma Aldrich, 99.9%), IrO₂ (Sigma Aldrich, 99.9%), Co₃O₄ (Sigma Aldrich), and Sc₂O₃ (Sigma Aldrich, 99.9%) were thoroughly ground and calcined at 1150° C. (for SrCo_{0.5}Ir_{0.5}O₃) or 1350° C. (for SrSc_{0.5}Ir_{0.5}O₃) for 12 hours under ambient air.

### A. Electrode preparation and Electrochemical Characterization

The electrodes were prepared by drop-casting as-prepared catalyst ink on a glassy carbon rotating electrode with a diameter of 5 mm (Pine Research Instrumentation). The catalyst loading was fixed at 0.05 mg. Specifically, the ink was prepared by mixing 2.5 mg catalyst powder with 1 mg acetylene black carbon, which was ultrasonically dispersed in a solution containing 375 μL H₂O, 112.5 μL isopropanol, and 12.5 μL Nafion solution (5 wt. %, Sigma Aldrich). 10 μL of well-dispersed ink was drop-casted onto the polished glassy carbon electrode, which was dried in ambient air until a robust catalyst layer formed. Note that, for evaluating the intrinsic activity (normalized to ECSA) of different samples and for estimating charge storage with pulse voltammetry, the catalyst inks were prepared without acetylene black carbon. The electrochemical tests were conducted in either 0.1 M KOH or 0.1 M HClO₄. OER measurements were performed with a biologic SP-150 potentiostat coupled with the modulated speed rotator (Pine Research Instrumentation). The glassy carbon electrode was used as the working electrode, a Pt wire was used as the counter electrode, and a saturated calomel electrode (SCE) was used as the reference electrode. The rotation speed for all tests was fixed at 1600 rpm. At least three measurements were performed when evaluating the OER activities of different catalysts. The pulse voltammetry was performed in the same electrochemical setup used for activity evaluation. Before pulse voltammetry tests, the electrodes were pre-treated for 50 cyclic voltammetry cycles (between 0.3 V and 1.8 V vs. RHE without iR correction) to ensure the reconstructed surfaces reaching the steady status. In pulse voltammetry, a low potential of 1.35 V, below the onset of OER, was selected, and the high potential changed from 1.42 V to 1.8 V with a step of 20 mV. For both anodic and cathodic sections, the duration was fixed at 10 seconds and the current was recorded every 0.001 second.

### B. Characterization

X-ray powder diffraction (XRD) measurements were performed with a BRUKER D8 Advance diffractometer in Bragg-Brentano geometry with Cu Kα radiation. A GSAS program and EXPGUI interface were used for the Rietveld refinement. TEM was performed on JEOL 2100F with UHR configuration. The EELS were collected with a Gatan 963 Quantum GIF SE, and the spectrum was processed with GMS3 software. The X-ray photoelectron spectroscopy (XPS) tests were performed using PHI-5400 equipment with Al Ka beam source (250 W) and position-sensitive detector. An XPSpeak41 software is applied for peak fitting. The BET surface areas were measured with nitrogen adsorption-desorption tests (ASAP Tri-star II 3020).

### C. XAS Measurements and Simulation

The samples for ex-situ XAS measurements were collected by performing the tests on a large working electrode with increased catalyst loading. Specifically, 50 mg of catalyst were loaded onto a large carbon paper (3*3 cm²). The cycling tests were performed in a three-electrode system (single cell) without electrode rotating. The hard XAS measurements at Ir L-edge and Co K-edge were performed at beamline 9-BM of the Advanced Photon Source (APS) at Argonne National Laboratory. The Athena and Artemis software packages were used for the data analysis. Soft XAS measurements (O K-edge) were carried out at 4-ID-C at APS. Calculations of the O K-edge XANES were performed using the finite difference method as implemented within the Finite Difference Method Near Edge Scattering (FDMNES) package using a free form SCF potential of radius 6.0 Å around the absorbing atom. Broadening contributions due to the finite mean-free path of the photoelectron and to the core-hole lifetime were accounted for using an arctangent convolution.

### D. TOF Calculation

The overpotential required to reach a TOF of 0.03 s⁻¹ is obtained from FIG. 4b by calculating the corresponding current density of j_{ECSA} (normalized to ECSA). The j_{ECSA} is estimated using the equation:

$${j}_{ECSA} = T O F \times 4 \times e \times {ρ}_{Ir} ,$$

where e is the electric charge carried by a single electron, and ρ_{Ir} is the surface density of Ir atoms. While calculating the ρ_{Ir}, different surface atom arrangements are considered. For IrO₂ (110) film with a stable surface, the (110) facet is considered and the lattice parameters are from the reference. For SSI-OH with a stable surface, the B-site Sc and Ir were assumed to be fully ordered to simplify the calculation. Two cases of the (100) facet (with the lowest Ir density) and (001) facet (with the highest Ir density) were considered. The refined lattice parameters from Table 2 were used for calculations. For SCI-OH, SSI-H, and SCI-H with reconstructed surfaces, two optimized structures of H₂IrO₃ (honeycomb) and IrOOH (brucite) were considered. In both structures, the (001) facet (with the highest Ir density) was used. The lattice parameters are obtained from DFT calculations.

### E. DFT Calculations

The spin-polarized DFT calculations were performed using the Vienna Ab Initio Simulation Package, employing the projected augmented wave (PAW) model. The exchange and correlation effect was described by Perdew-Burke-Ernzerhof (PBE) functional. J. P. Perdew, K. Burke, M. Ernzerhof, Generalized gradient approximation made simple. Phys. Rev. Lett. 77, 3865 (1996). The GGA+U calculations were performed using the model proposed by Dudarev et al. [S. Dudarev, G. Botton, S. Savrasov, C. Humphreys, A. Sutton, Electron-energy-loss spectra and the structural stability of nickel oxide: An LSDA+U study. Phys. Rev. B. 57, 1505 (1998)], with the U_{eff}(U_{eff}=Coulomb U−exchange J) values of 1 eV, 3.3 eV, and 3 eV for Ir, Co, and Sc, respectively. In all the calculations, the cutoff energy was set to be 450 eV. The Monkhorst-Pack k-point meshes were set to be 6×6×5 and 2×2×1 for performing the bulk and surface calculations of the perovskite structure, respectively. H. J. Monkhorst, J. D. Pack, Special points for Brillouin-zone integrations. Phys. Rev. B. 13, 5188 (1976). The force and energy convergence tolerance were set to be 0.05 eV Å⁻¹ and 10⁻⁵ eV, respectively.

The OER free energies were calculated based on the following four elementary steps:

OH-+*→*OH+e−

*OH+OH-→*O+H₂O+e−

*O+OH-→*OOH+e−

*OOH+OH-→+O₂+H₂O+e−

where * denotes the cation sites on the catalyst surface. Based on the above mechanism, the free energies of the three intermediate states, *OH, *O, and *OOH, are crucial in determining the OER activity of a given material.

The computational hydrogen electrode (CHE) model [J. K. Nørskov, J. Rossmeisl, A. Logadottir, L. Lindqvist, J. R. Kitchin, T. Bligaard, H. Jonsson, Origin of the overpotential for oxygen reduction at a fuel-cell cathode. J. Phys. Chem. B. 108, 17886-17892 (2004)] was used to evaluate the energy state of the OER intermediates, where the free energy of an adsorbed species is defined as

$$Δ {G}_{ads} = Δ {E}_{ads} + Δ {E}_{𝓏 pe} - T Δ {S}_{ads} .$$

With reference to this formula, ΔE_{ads} is the electronic adsorption energy, ΔE_{ZPE} is the zero-point energy difference between adsorbed and gaseous species, and TΔS_{ads} is the corresponding entropy difference between these two states. The electronic binding energy is referenced as ½ H₂ for each H atom, and (H₂O—H₂) for each O atom, plus the energy of the clean slab. The corrections of zero-point energy and entropy of the OER intermediates are provided by Table 6.

TABLE 6
Correction of Zero-Point Energy and Entropy
of the Adsorbed and Gaseous species.

| | ZPE(EV) | TS(EV) |
|---|---|---|
| *OOH | 0.35 | 0 |
| *O | 0.05 | 0 |
| *OH | 0.31 | 0.01 |
| H₂O | 0.56 | 0.67 |
| H₂ | 0.27 | 0.41 |

The surface Pourbaix diagram was calculated based on the method proposed by Hansen et al. [H. A. Hansen, J. Rossmeisl, J. K. Nørskov, Surface Pourbaix diagrams and oxygen reduction activity of Pt, Ag and Ni (111) surfaces studied by DFT. Phys. Chem. Chem. Phys. 10, 3722-3730 (2008)], where the free energy of oxygen and hydroxyl exchange at a given surface at any pH and potential is calculated as

$$G ( {HO}^{*} ) = Δ {G}_{0} ( {HO}^{*} ) - e {U}_{SHE} - {k}_{B} T ln 10 pH + Δ {G}_{field}$$

where ΔG_{field} is the change in the adsorption energy due to the electric field in the electrochemical double layer at the cathode. According to the work by Rossmeisl et al., [J. Rossmeisl, J. K. Nørskov, C. D. Taylor, M. J. Janik, M. Neurock, Calculated phase diagrams for the electrochemical oxidation and reduction of water over Pt (111). The J. Phys. Chem. B. 110, 21833-21839 (2006)], the relative stability change of O* and OH* under electric field is more than one-order magnitude lower than the change of free energy. Therefore, the trend in adsorption energies can be well described by neglecting ΔG_{field} in the construction of the surface Pourbaix diagram.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
providing an initial compound having a perovskite lattice structure according to formula I
M¹M²M³O₃ FORMULA I
where M¹ is 1 relative elemental ratio strontium (Sr); M² is from greater than 0 to 0.7 relative elemental ratio, and is selected from cobalt (Co), scandium (Sc), iron (Fe), nickel (Ni), and titanium (Ti); and M³ is 0.3 to 0.6 relative elemental ratio iridium (Ir);
selectively leaching metal cations from the initial compound by electrochemical cycling to produce a catalyst having increased catalytic performance compared to the initial compound.

2. The method according to claim 1 wherein:
the initial compound comprises 0.5 relative elemental ratio M²;
M² comprises Sc or Co; or
the initial compound comprises 0.5 relative elemental ratio M² and M² comprises Sc or Co.

3. The method according to claim 1 wherein M¹ is strontium, M² is selected from cobalt and scandium, and M³ is iridium.

4. The method according to claim 1, comprising leaching strontium atoms from a crystalline perovskite lattice to form an amorphous surface having reduced strontium concentration.

5. The method according to claim 1, wherein selectively leaching metal cations from the initial compound comprises electrochemically cycling the initial compound plural times in a base or an acid.

6. The method according to claim 5 wherein:
the base is a metal hydroxide and the acid is perchloric acid;
cycling continues until the initial compound reaches a steady state; or
the base is a metal hydroxide and the acid is perchloric acid and cycling continues until the initial compound reaches a steady state.

7. The method according to 5 wherein:
the initial compound is cycled in a base to produce SSI-OH or SCI-OH; or
the initial compound is cycled in an acid to produce SSI-H or SCI-H.

8. The method according to claim 5, where cycling:
reconstructs the perovskite surface from a crystalline structure to an amorphous structure with A-site cation (Sr) leaching, which induces an activity improvement of approximately one order of magnitude;
leaches B-site cations, which induces further activity improvement of approximately one order of magnitude;
increases surface area available for catalytic activity; or
any and all combinations thereof.

9. The method according to claim 1 wherein:
the initial compound is SrSc_{0.5}Ir_{0.5}O₃ (SSI) or SrCo_{0.5}Ir_{0.5}O₃ (SCI);
the catalyst is SSI-OH, SCI-OH, SSI-H or SCI-H; or
the initial compound is SrSc_{0.5}Ir_{0.5}O₃ (SSI) or SrCo_{0.5}Ir_{0.5}O₃ (SCI) and the catalyst is SSI-OH, SCI-OH, SSI-H or SCI-H.

10. The method according to claim 1 wherein:
the catalyst has an activity increase of 150 times relative to that of the initial compound;
the catalyst has an activity of 1.5 Volts versus a reversible hydrogen electrode (RHE); or
the catalyst has an activity increase of 150 times relative to that of the initial compound and the catalyst has an activity of 1.5 Volts versus a reversible hydrogen electrode (RHE).

11. The method according to claim 1, wherein:
i) cation leaching forms a highly active amorphous IrOₓH_{y} surface phase where X and Y fulfill an equation 4+Y=2X;
ii) the catalyst has an amorphous IrOₓH_{y} surface structure selected from IrO₂-rutile, H₂IrO₃-honeycomb, H₂IrO₃-F, and IrOOH-brucite; or
iii) a combination of i) and ii).

12. The method according to claim 1 wherein:
subsequent to cycling in acid, the compound is SSI-H or SCI-H and the strontium surface concentration is reduced to 0.2 elemental ratio or less; or
subsequent to cycling in base, the compound is SCI-OH and the strontium surface concentration is reduced to 0.6 relative elemental ratio to 0.7 relative elemental ratio.

13. The method according to claim 1, wherein the catalyst has from 0.1 to 0.3 relative elemental ratio Sr.

14. The method according to claim 1, wherein:
i) the catalyst has a honeycomb surface structure and an electrochemical surface area higher than that of the initial compound;
ii) the catalyst has an amorphous surface structure having a depth of greater than 0 nanometers to at least 50 nanometers; or
iii) a combination of i) and ii).

15. The method according to claim 1, wherein:
the catalyst is SCI-H having a BET-normalized activity of 7.5±1.0 mA cm⁻²;
the catalyst is SSI-H having a BET-normalized activity of 3.5±0.5 mA cm⁻²;
the catalyst is SCI-OH having a BET-normalized activity of 0.4±0.1 mA cm⁻²; or
the catalyst is SSI-OH having a BET-normalized activity of 0.05±0.01 mA cm⁻².

16. The method according to claim 1, wherein the current density is normalized to electrochemical surface area (ECSA) at 1.5 V versus RHE (instinct activity), and:
the catalyst is SCI-H having an ECSA-normalized activity of from 0.055 to 0.40 mA cm⁻²;
the catalyst is SSI-H having an ECSA-normalized activity of from 0.07 to 0.54 mA cm⁻²);
the catalyst is SCI-OH having an ECSA-normalized activity of from 0.008 to 0.046 mA cm⁻²; or
the catalyst is SSI-OH having an ECSA-normalized activity of from 0.015 to 0.03 mA cm⁻².

17. The method of claim 1, where M¹ is 1 relative elemental ratio strontium (Sr); M² is from greater than 0 to 0.7 relative elemental ratio, and is selected from cobalt (Co) and scandium (Sc); and M³ is 0.3 to 0.6 relative elemental ratio iridium (Ir); and
selectively leaching metal cations comprises electrochemically cycling the initial compound plural times in a base or an acid to produce the catalyst having increased catalytic performance compared to the initial compound.

18. A method, comprising:
calcining appropriate stochiometric amounts of reagents selected from SrCO₃, IrO₂, Co₃O₄, and Sc₂O₃ (Sigma Aldrich, 99.9%) at a temperature of 1,100° C. or greater to form an initial compound selected from SrSc_{0.5}Ir_{0.5}O₃ (SSI) or SrCo_{0.5}Ir_{0.5}O₃ (SCI);
electrochemically cycling the initial compound in an acid to produce SSI-H or SCI-H where the strontium surface concentration is reduced to 0 relative elemental ratio to 0.2 relative elemental ratio, or electrochemically cycling the initial compound in an base to produce SSI-OH or SCI-OH where the strontium concentration is reduced to between 0.5 relative elemental ratio to 0.7 relative elemental ratio, where electrochemical cycling forms a catalyst having a highly active amorphous H₂IrO₃-honeycomb surface phase having a depth of greater than 0 nanometers to at least 50 nanometers.

19. A catalyst, produced according to the method of claim 1.

20. A catalyst, comprising:
a core portion having a formula I
M¹M²M³O₃ FORMULA I,
where M¹ is 1 relative elemental ratio strontium (Sr); M² is from greater than 0 to 0.7 relative elemental ratio, and is selected from cobalt (Co) and scandium (Sc); and M³ is 0.3 to 0.6 relative elemental ratio iridium (Ir); and
an outer surface portion from which M¹ and/or M² cations have been selectively leached from the initial compound in an acid, thereby reducing the strontium concentration in the outer surface portion to a range between 0 relative elemental ratio to 0.2 relative elemental ratio, or M¹ and/or M² cations have been selectively leached from the initial compound in a base, thereby reducing the strontium concentration in the outer surface portion to a range between 0.6 relative elemental ratio to 0.7 relative elemental ratio, relative to the core portion concentration, the outer surface portion extending from the surface to a depth of greater than 0 to at least 50 nanometers.

21. A method, comprising:
providing a catalyst according to claim 19; and
using the catalyst or catalysts to perform a catalytic reaction.
